(19) United States
(12) Patent Application Publication
(10) Pub. No.: US 2003/0065669 A1
(43) Pub. Date: Apr. 3, 2003

(54) Timeline forecasting for clinical trials

(75) Inventors: Michael G. Kahn, Boulder, CO (US); Michael Mischke-Reeds, San Francisco, CA (US); John H. Nguyen, San Jose, CA (US)

Correspondence Address: HAYNES BEFFEL & WOLFELD LLP, P O BOX 366, HALF MOON BAY, CA, 94019, US

(73) Assignee: FastTrack Systems, Inc.

(21) Appl. No.: 09/970,182

(22) Filed: Oct. 3, 2001

(51) Int. Cl. G06F 7/00

(52) U.S. Cl. 707/100

(57) ABSTRACT

Roughly described, a machine-readable protocol database identifies a sequence of workflow tasks for a clinical trial protocol. The sequence of workflow tasks is organized as a graph whose nodes can contain or represent patient contact event objects, with one or more of the tasks assigned to each patient contact event object. The graph also indicates preferred or expected times for a patient to transition from one node to the next, and optionally also indicates a predicted likelihood that different alternative paths will be taken to a common destination node. A problem-solving method automatically extracts the time duration expected or predicted for a patient to traverse each separate phase of the protocol. Such durations are provided to a simulation engine which automatically generates timeline forecasts of patient progress through at least part of the workflow tasks prescribed by the protocol.

### BACKGROUND

1. Field of the Invention

The invention relates to the field of medical informatics, and more particularly to a system and method using medical informatics primarily to predict study progress timelines based on easily modifiable assumptions.

2. Description of Related Art

Over the past number of years, the pharmaceutical industry has enjoyed great economic success. The future, however, looks more challenging. During the next few years, products representing a large percentage of gross revenues will come off patent, increasing the industry's dependence upon new drugs. But even with new drugs, with different companies using the same development tools and pursuing similar targets, first-in-category market exclusivity has also fallen dramatically. Thus in order to compete effectively in the future, the pharmaceutical industry needs to increase throughput in clinical development substantially. And this must be done much faster than it has in the past—time to market is often the most important factor driving pharmaceutical profitability.

A. Clinical Trials: the Now and Future Bottleneck

In U.S. pharmaceutical companies alone, a huge percentage of total annual pharmaceutical research and development funds is spent on human clinical trials. Spending on clinical trials is growing at approximately 15% per year, almost 50% above the industy's sales growth rate. Trials are growing both in number and complexity. For example, the average new drug submission to the U.S. Food & Drug Administration (FDA) now contains more than double the number of clinical trials, more than triple the number of patients, and a more than a 50% increase in the number of procedures per trial, since the early 1980s.

An analysis of the new drug development process shows a major change in the drivers of time and cost. The discovery process, which formerly dominated time to market, has undergone a revolution due to techniques such as combinatorial chemistry and high-throughput screening. The regulatory phase has been reduced due to FDA reforms and European Union harmonization. In their place, human clinical trials have become the main bottleneck. The time required for clinical trials now approaches 50% of the 15 years or so required for the average new drug to come to market.

B. The Trial Process Today

The conduct of clinical trials has changed remarkably little since trials were first performed in the 1940's. Clinical research remains largely a manual, labor-intensive, paper based process reliant on a cottage industry of physicians in office practices and academic medical centers.

1. Initiation

A typical clinical trial begins with the construction of a clinical protocol, a document which describes how a trial is to be performed, what data elements are to be collected, and what medical conditions need to be reported immediately to the pharmaceutical sponsor and the FDA. The clinical protocol and its author are the ultimate authority on every aspect of the conduct of the clinical trial. This document is the basis for every action performed by multiple players in diverse locations during the entire conduct of the trial. Any deviations from the protocol specifications, no matter how well intentioned, threaten the viability of the data and its usefulness for an FDA submission.

The clinical protocol generally starts with a cut-and-paste word-processor approach by a medical director who rarely has developed more than 1-2 drugs from first clinical trial to final regulatory approval and who cannot reference any historical trials database from within his or her own company-let alone across companies. In addition, this physician typically does not have reliable data about how the inclusion or exclusion criteria, the clinical parameters that determine whether a given individual may participate in a clinical trial, will affect the number of patients eligible for the study.

A pharmaceutical research staff member typically translates portions of the trial protocol into a Case Report Form (CRF) manually using word-processor technology and personal experience with a limited number of previous trials. The combined cutting and pasting in both protocol and CRF development often results in redundant items or even irrelevant items being carried over from trial to trial. Data managers typically design and build database structures manually to capture the expected results. When the protocol is amended due to changes in FDA regulations, low accrual rates, or changing practices, as often occurs several times over the multiple years of a big trial, all of these steps are typically repeated manually.

At the trial site, which is often a physician's office, each step of the process from screening patients to matching the protocol criteria, through administering the required diagnostics and therapeutics, to collecting the data both internally and from outside labs, is usually done manually by individuals with another primary job (doctors and nurses seeing ‘routine patients’) and using paper based systems. The result is that patients who are eligible for a trial often are not recruited or enrolled, errors in following the trial protocol occur, and patient data are often either not captured at all, or are incorrectly transcribed to the CRF from hand written medical records, and are illegible. An extremely large percentage of the cost of a trial is consumed with data audit tasks such as resolving missing data, reconciling inconsistent data, data entry and validation. All of these tasks must be completed before the database can be “locked,” statistical analysis can be performed and submission reports can be created.

2. Implementation

Once the trial is underway, data begins flowing back from multiple sites typically on paper forms. These forms routinely contain errors in copying data from source documents to CRFs.

Even without transcription errors, the current model of retrospective data collection is severely flawed. It requires busy investigators conducting multiple trials to correctly remember and apply the detailed rules of every protocol. By the time a clinical coordinator fills out the case report form the patient is usually gone, meaning that any data that were not collected or treatment protocol complexities that were not followed are generally unrecoverable. This occurs whether the case report form is paper-based or electronic. The only solution to this problem is point-of-care data capture, which historically has been impractical due to technology limitations.

Once the protocol is in place it often has to be amended. Reasons for changing the protocol include new FDA guidelines, amended dosing rules, and eligibility criteria that are found to be so restrictive that it is not possible to enroll enough patients in the trial. These “accrual delays” are among the most costly and time-consuming problems in clinical trials.

The protocol amendment process is extremely labor intensive. Further, since protocol amendments are implemented at different sites at different times, sponsors often don't know which version of the protocol is running where. This leads to additional ‘noise’ in the resulting data and downstream audit problems. In the worst case, patients responding to an experimental drug may not be counted as responders due to protocol violations, but may even count against the response rate under an intent-to-treat analysis. It is even conceivable that this purely statistical requirement could cause an otherwise use fall drug to fail its trials.

Sponsors, or Contract Research Organizations (CROS) working on behalf of sponsors, send out armies of auditors to check the paper CRFs against the paper source documents. Many of the errors they find are simple transcription errors in manually copying data from one paper to the other. Other errors, such as missing data or protocol violations, are more serious and often unrecoverable.

3. Monitoring

The monitoring and audit functions are one of the most dysfunctional parts of the trial process. They consume huge amounts of labor costs, disrupt operations at trial sites, contribute to high turnover, and often involve locking the door after the horse has bolted.

4. Reporting

As information flows back from sites, the mountain of paper grows. The typical New Drug Application (NDA) literally fills a semi-truck with paper. The major advance in the past few years has the addition of electronic filing, but this is basically a series of electronic page copies of the same paper documents—it does not necessarily provide quantitative data tables or other tools to automate analysis.

B. The Costs of Inefficiency

It can be seen that this complex manual process of clinical trials is highly inefficient and slow. And since each trial is largely a custom enterprise, the same thing happens all over again with the next trial. Turnover in the trials industry is also high, so valuable experience from trial to trial and drug to drug is often lost.

The net result of this complex, manual process is that despite accumulated experience, each successive trial costs more to conduct.

In addition to being slow and expensive, the current clinical trial process often hurts the market value of the resulting drug in two important ways. First, the FDA reviews drugs on an “intent to treat” basis. That means that every patient enrolled in a trial is included in the denominator (positive responders/total treated) when calculating a drug's efficacy. However, only patients who respond to treatment and comply with the protocol are included in the numerator as positive responders. Not infrequently, a patient responds to a drug favorably, but is actually counted as a failure due to significant protocol non-compliance. In rare cases, an entire trial site is disqualified due to non-compliance. Non-compliance is often a result of preventable errors in patient management.

The second major way that the current clinical trail process hurts drug market value is that much of the fine grain detail about the drug and how it is used is not captured and passed from clinical development to marketing within a pharmaceutical company. As a result, virtually every pharmaceutical company has a second medical department that is a part of the marketing group. This group often repeats studies similar to those used for regulatory approval in order to capture the information necessary to market the drug effectively. This is a redundant cost that could be avoided if the data could be captured from the clinical trials and passed on.

C. The Situation at Trial Sites

Despite the existence of a large number of clinical trials that are actively recruiting patients, only a tiny percentage of eligible patients are enrolled any clinical trial. Physicians, too, seem reluctant to engage in clinical trials. One study by the American Society of Clinical Oncology found that barriers to increased enrollment included restrictive eligibility criteria, large amount of required paperwork, insufficient support staff, and lack of sufficient time for clinical research.

Clinical trials consist of a complex sequence of steps. On average, a clinical trial requires more than 10 sites, enrolls more than 10 patients per site and contains more than 50 pages for each patient's CRF. Given this complexity, delays are a frequent occurrence. A delay in any one step, especially in early steps such as patient accrual, propagates and magnifies that delay downstream in the sequence.

A significant barrier to accurate accrual planning is the difficulty trial site investigators have in predicting their rate of enrollment until after a trial as begun. Even experienced investigators tend to overestimate the total number of enrolled patients they could obtain by the end of the study. Novice investigators tend to overestimate recruitment potential by a larger margin than do experienced investigators, and with the rapid increase in the number of investigators participating in clinical trials, the vast majority of current investigators have not had significant experience in clinical trials.

D. Absence of Information Infrastructure

Given the above state of affairs, one might expect that the clinical trials industry would be ripe for automation. But despite the desperate need for automation, remarkably little has been done.

While the pharmaceutical industry spends hundreds of millions of dollars annually on clinical information systems, most of this investment is in internal custom databases and systems within the pharmaceutical company; very little of this technology investment is at the physician office level. Each trial, even when conducted by the same company or when testing the same drug, is usually a custom collection of sites, procedures and protocols. More than half of trials are conducted for the pharmaceutical industry by Contract Research Organizations (CROs) using the same manual systems and custom physician networks.

The clinical trials information technology environment contributes to this situation. Clinical trials are information-intensive processes—in fact, information is their only product. Despite this, there is no comprehensive information management solution available. Instead there are many vendors, each providing tools that address different pieces of the problem. Many of these are good products that have a role to play, but they do not provide a way of integrating or managing information across the trial process.

The presently available automation tools include those that fall into the following major categories:

Clinical data capture (CDC)

Site-oriented trial management

Electronic Medical Records (EMRs) with Trial-Support Features

Trial Protocol design tools

Site-sponsor matching services

Clinical data management

Clinical Research Organizations (CROs) and Site Management Organizations (SMOs) also provide some information services to trial sites and sponsors.

1. Clinical Data Capture (CDC) Products

These products are targeted at trial sites, aiming to improve speed and accuracy of data entry. Most are rapidly moving to Web-based architectures. Some offer off-line data entry, meaning that data can be captured while the computer is disconnected from the Internet. Most CDC vendors can point to half a dozen pilot sites and almost no paying customers.

These products do not create an overall, start-to-finish, clinical trials management framework. These products also see “trial design” merely as “CRF design,” ignoring a host of services and value that can be provided by a comprehensive clinical trials system. They also fail to make any significant advance over conventional methods of treating each trial as a “one-off” activity. For example, the companies offering CDC products continue to custom-design each CRF for each trial, doing not much more than substituting HTML code for printed or word-processor forms.

2. Site-Oriented Trial Management

These products are targeted at trial sites and trial sponsors, aiming to improve trial execution through scheduling, financial management, accrual, visit tracking. These products do not provide electronic clinical data entry, nor do they assist in protocol design, trial planning for sponsors, patient accrual or task management.

3. Electronic Medical Records (EMR) with Trial-Support Features

These products aim to support patient management of all patients, not just study patients, replacing most or all of a paper charting system. Some EMR vendors are focusing on particular disease areas, with KnowMed being a notable example in oncology.

These products for the most part do not focus specifically on the features needed to support clinical trials. They also require major behavior changes affecting every provider in a clinical setting, as well as requiring substantial capital investments in hardware and software. Perhaps because of these large hurdles, EMR adoption has been very slow.

4. Trial Protocol Design Tools

These products are targeted at trial sponsors, aiming to improve the protocol design and program design processes using modeling and simulation technologies. One vendor in this segment, PharSight, is known for its use of PK/PD (pharmacokinetic/pharacodynamic) modeling tools and is extending its products and services to support trial protocol design more broadly.

None of the companies offering trial protocol design tools provide the host of services and value that can be provided by a comprehensive clinical trials system.

5. Trial Matching Services

Some recent Web-based services aim to match sponsors and sites, based on a database of trials by sponsor and of sites' patient demographics. A related approach is to identify trials that a specific patient maybe eligible for, based on matching patient characteristics against a database of eligibility criteria for active trials. This latter functionality is often embedded in a disease-specific healthcare portal such as cancerfacts.com.

6. Clinical Data Management

Two well-established products, Domain ClinTrial and Oracle Clinical, support the back-end database functionality needed by sponsors to store the trial data coming in from CRFs. These products provide a visit-specific way of storing and querying study data. The protocol sponsor can design a template for the storage of such data in accordance with the protocol's visit schema, but these templates are custom-designed for each protocol. These products do not provide protocol authoring or patient management assistance.

7. Statistical Analysis

The SAS Institute (SAS) has defined the standard format for statistical analysis and FDA reporting. This is merely a data format, and does not otherwise assist in the design or execution of clinical trial protocols.

8. Site Management Organizations (SMOs)

SMOs maintain a network of clinical trial sites and provide a common Institutional Review Board (IRB) and centralized contracting/invoicing. SMOs have not been making significant technology investments, and in any event, do not offer trial design services to sponsors.

9. Clinical Research Organizations (CROs)

CROs provide, among other services, trial protocol design and execution services. But they do so on substantially the same model as do sponsors: labor-intensive, paper-based, slow, and expensive. CROs have made only limited investments in information technology.

E. The Need for a Comprehensive Clinical Trials System

It can be seen that the current information model for clinical trials is highly fragmented. This has led to high costs, “noisy” data, and long trial times. Without a comprehensive, service-oriented information solution it is very hard to get away from the current paradigm of paper, faxes and labor-intensive processes. And it has become clear that simply “throwing more bodies” at trials will not produce the required results, particularly as trial throughput demands increase.

One example where the current fragmented approach to clinical trials management has an adverse impact is in the prediction of clinical trial timelines. The time to completion of a study depends on a large number of factors including the time to study commencement at each participating clinical site, the monthly rate at which patients actually enroll at each clinical site, the number of patient visits required for each patient, and the time between patient visits. Much of these data are highly uncertain because they depend on human performance. The time to study commencement depends, for example, on such factors as the time required to conclude contract negotiations, the time required to receive all FDA-mandated pre-study forms, the time required for approval of the study by each site's Institutional Review Board (IRB) and Scientific Review Board (if any), the time required for a pre-study site inspection, and the date of the pre-study investigator's meeting. Most of these factors may vary by study site. The monthly rate of patient enrollment is also study-site dependent, and depends further on such factors as the actual number of patients that match the eligibility criteria, the presence or absence of competing trials or other competing therapies, staffing levels and staff turnover at the site, the diligence of the site's personnel in searching for and pursuing accrual candidates, the level of interest that the site's supervising physician takes in the particular study, and the level of experience of the site's supervising physician.

The time from the enrollment of a particular patient to the time the patient's involvement in the study has completed, in certain circumstances can be predicted with more certainty. For example, if the clinical trial protocol schema, which governs the workflow of a patient through a clinical trial, is relatively straightforward (contains few if any conditional branching steps), then the patient's progress through the schema often can be calculated in advance given certain assumptions about the average, or specified minimum and maximum, time between visits. Human factors come into play here as well, however, since patient and study site compliance with the specified times between visits is not always reliable. Timeline prediction becomes significantly more complex as the complexity of the protocol schema increases, for example with the inclusion of many conditional branching steps, prescribed repetition of portions of the schema in dependence upon patient response to treatment, prescribed delays conditioned on patient toxicity, and so on.

Study sponsors are keenly interested in the time that will be required to complete a clinical trial because of the significant costs incurred by any unnecessary delay. Study sponsors would consider it most advantageous if these issues could be taken into account during protocol design stage, so that time-to-completion could be optimized. Protocol designers do often try to optimize new protocols for speed by applying certain rules-of-thumb, such as assigning more workflow tasks to be performed at each patient visit to potentially thereby reduce the total number of patient visits required. But it is not always obvious whether a small change in the protocol schema will yield any improvement in the study timeline, nor is the detrimental effect on the study timeline always apparent when a change is made in order to provide more robust results. The same relative unpredictability exists for the effects of design-time changes to the basic study assumptions, such as the number of clinical sites, site setup time, monthly rate of patient enrollment, etc.

Currently, general purpose software programs such as Microsoft Project and Microsoft Excel are commonly used to try to assist in the forecasting of study progress. Such programs have a number of limitations, including the following. First, they require manual inputting of assumptions which are typically based mostly on “gut feel”. The input assumptions are rarely linked to historical data and never linked to a model of the study.

Second, the projects and spreadsheets created for use with these programs have little potential for re-use. Each study is a one-off process.

Third, these programs have difficulty modeling dynamic characteristics of the study, such as branching protocols where the number of treatment visits is indeterminate.

Fourth, these programs do not treat uncertainty, and therefore do not help a user to understand how uncertainty of input assumptions (e.g., study setup time and monthly patient enrollment) affects the uncertainty of outputs (e.g., time to enrollment close or time to study completion).

Nor are such programs any more useful during study execution, when study sponsors are often interested to know the effect on the outputs when actual experience to date (e.g., in site setup times, in monthly patient enrollment rates, and in per-patient progress through the protocol schema) differs from the assumptions on which the pre-study predictions were based.

Accordingly, it would be greatly desirable to provide a much more highly automated mechanism in which a protocol designer can make a change to the protocol and see immediately, or almost immediately, what effect that change has on the expected study timeline. It would also be greatly desirable to provide a mechanism in which a study sponsor or other user can easily update protocol and study assumptions based on actual experience to date, and see immediately, or almost immediately, how the forecasting changes.

### SUMMARY OF THE INVENTION

According to the invention, roughly described, clinical trials are defined, managed and evaluated according to an overall end-to-end system solution which covers both the protocol design and the actual conduct of trials by clinical sites. A protocol designer chooses a meta-model and preliminary eligibility criteria list appropriate for the relevant disease category, and encodes the clinical trial protocol, including eligibility and patient workflow, into a machine-readable protocol database. This protocol database then drives most subsequent aspects of the trial.

Study sites make reference to the protocol databases in order to identify clinical studies for which individual patients are eligible, and patients who are eligible for individual clinical studies. The data that are gleaned from patients being screened can be retained in a patient-specific database of patient attributes, or they can be stored anonymously or discarded after screening. Once a patient is enrolled into a study, the protocol database indicates to the clinician exactly what tasks are to be performed at each patient visit. The workflow graph embedded in the protocol database advantageously also instructs the proper time for the clinician to obtain informed consent from a patient during the eligibility screening process, and when to perform future tasks, such as the acceptable date range for the next patient visit.

The system keeps track of the progress of the patient through the workflow graph of a particular protocol. The system reports this information to study sponsors, who can then monitor the progress of an overall clinical trial in near-real-time, and to the central authority which can then generate performance metrics for the study site.

The use of a machine-readable protocol database to store most significant aspects of a clinical trial protocol enables the development of automated tools to analyze the protocol and provide timely information to the protocol designer and the sponsor. In one aspect of the invention, roughly described, a machine-readable protocol database identifies a sequence of workflow tasks for a clinical trial protocol. The workflow tasks can include pre-enrollment tasks, post-enrollment-pre-treatment tasks, treatment-stage tasks and post-treatment-stage tasks, and can define both patient management tasks as well as data management tasks. The sequence of workflow tasks is organized as a graph whose nodes can contain or represent patient contact event objects, with one or more of the tasks assigned to each patient contact event object. The graph also indicates preferred or expected times for a patient to transition from one node to the next, and optionally also indicates a predicted likelihood that different alternative paths will be taken to a common destination node.

Once these time indications are embedded into a machine-readable protocol database, a problem-solving method is used to automatically extract the time duration expected or predicted for a patient to traverse each separate phase of the protocol. Such durations are provided to a simulation engine, which automatically generates timneline forecasts of patient progress through at least part of the workflow tasks prescribed by the protocol. The simulation engine can also be designed to receive input assumptions regarding site setup and enrollment timetables, and generate resulting timeline forecasts predicting the total number of patients expected to be in each protocol stage at any given time, and the date on which the last-patient-last-visit is expected.

The system described herein offers significant benefits at study design time because it allows the design to be optimized through the use of quickly executed “what-if?” scenarios. The study designer can very quickly determine the effect on the forecasts of modified input assumptions or protocol details simply by modifying them in their machine readable form and re-running the simulation. The system offers significant benefits during study execution as well, because actual data regarding site startup times, patient enrollment and per-patient progression through the protocol schema canbe used to refine the input assumptions and quickly generate revised forecasts. In addition, if probabilistic approaches are used, the distributions in the output forecasts can be significantly narrowed as the study progresses by using actual experience to date to narrow input probability distributions that were assumed at design time.

### BRIEF DESCRIPTION OF THE DRAWINGS

The invention will be described with respect to specific embodiments thereof, and reference will be made to the drawings, in which:

FIG. 1 is a symbolic block diagram illustrating significant aspects of a clinical trials management system and method incorporating features of the invention.

FIGS. 2-8 are screen shots of an example for an Intelligent Clinical Protocol (iCP) database.

FIG. 9 is a flow chart detail of the step of creating iCPs in FIG. 1.

FIG. 10 is a flow chart of an optional method for a protocol author to establish patient eligibility criteria.

FIGS. 11-25 are screen shots of screens produced by Protégé 2000, and will help illustrate the relationship between a protocol meta-model and an example individual clinical trial protocol.

FIG. 26 is a flow chart detail of step 122 (FIG. 1).

FIGS. 27-33 are additional screen shots produced by Protégé 2000, illustrating parts of an iCP class structure.

FIG. 34 is a flow diagram implementing an embodiment of the invention for timeline forecasting.

FIGS. 35-38 are flow charts illustrating an algorithm for extracting protocol stage duration values from a protocol database for use in the flow diagram of FIG. 34.

FIG. 39 is a diagram of a portion of a sample protocol schema.

FIG. 40 illustrates a sample output from the flow diagram of FIG. 34.

### DETAILED DESCRIPTION

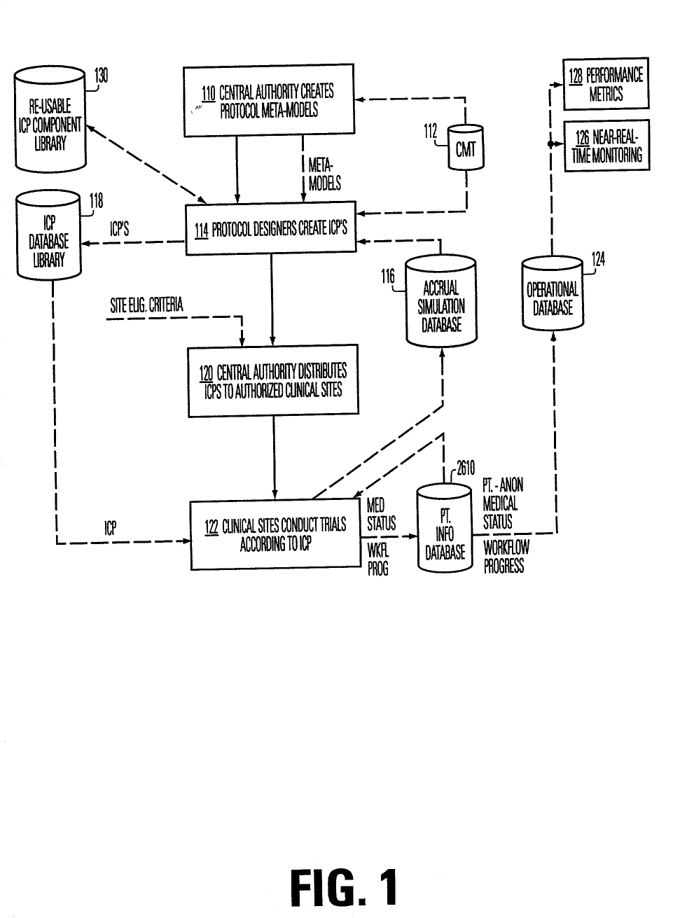

FIG. 1 is a symbolic block diagram illustrating significant aspects of a clinical trials management system and method incorporating features of the invention. In the figure, solid arrows indicate process flow, whereas broken arrows indicate information flow. In broad summary, the system is an end-to-end solution which starts with the creation of protocol meta-models by a central authority, and ends with the conduct of trials by clinical sites, who then report back electronically for near-real-time monitoring by study sponsors, for analysis by the central authority, and for use by study sponsors in identifying promising sites for future studies. As used herein, a “clinical site” can be physically at a single or multiple locations, but conducts clinical trials as a single entity. The term also includes SMOs.

Referring to FIG. 1, the central authority initially creates one or more protocol meta-models (step 110) for use in facilitating the design of clinical trial protocols. Each meta-model can be thought of as a set of building blocks from which particular protocols can be built. Preferably, the central authority creates a different meta-model for each of several disease classifications, with the building block in each meta-model being appropriate to that disease classification. In an embodiment, a meta-model is described in terms of object oriented design. The building blocks are represented as object classes, and an individual protocol database contains instances of the available classes.

The building blocks contained in a meta-model include the different kinds of steps that might be required in a trial protocol workflow, such as, for example, a branching step, an action step, a synchronization step, and so on. The available action steps for a meta-model directed to breast cancer trials might differ from the available action steps in a meta-model directed to prostate cancer trials, for example, by making available only those kinds of steps which might be appropriate for the particular disease category. For example, a step of brachytherapy might be available in the prostate cancer meta-model, but not in the breast cancer meta-model; and a step of mammography might be available in the breast cancer meta-model, but not in the prostate cancer meta-model.

In one embodiment, the meta-models also include lists, again appropriate to the particular disease category, within which a protocol designer can define preliminary criteria for the eligibility of patients for a particular study. These preliminary eligibility criteria lists do not preclude a protocol designer from building further eligibility criteria into any particular clinical trial protocol. Table I sets forth example Preliminary Eligibility Criteria lists for five disease categories, specifically breast cancer, small cell lung cancer, non-small cell lung cancer, colorectal cancer and prostate cancer. As can be seen, each list includes a small number of patient attributes, each with a set of available choices from which the protocol designer can choose, in order to encode preliminary eligibility criteria for a particular protocol. The protocol meta-model for breast cancer, for example, includes the list of attributes and the list of available choices for each attribute, as shown in the row of the table for “Breast Cancer.” In another embodiment, there are no separate preliminary eligibility criteria. All eligibility criteria are contained in the particular clinical trial protocol.

TABLE I
Example Preliminary Eligibility Criteria Lists

| | QUICKSCREEN | |
|---|---|---|
| Disease | attribute | Choices |
| Breast cancer | Current Stage | O, I, II (IIA, IIB), III (IIIA, IIIB), IV |
| | Prior Chemo | None, Neoadj/Adj, Tx Adv Disease |
| | Prior RT | None, Primary tumor, Metastatic Dz |
| | Prior Surgery | Y, N |
| | Prior | None, Neoadj/Adj, Tx Adv Disease |
| | Hormonal | |
| Lung cancer, | Current Stage | Limited, Extensive |
| small cell | Prior Chemo | None, Neoadj/Adj, Tx Adv Disease |
| | Prior RT | None, Primary tumor, Metastatic Dz |
| | Prior Surgery | Y, N |
| Lung cancer, | Current Stage | O, I (IA, IB), II (IIA, IIB), IIIA, |
| non-small | | IIIB, IV |
| cell | Prior Chemo | None, Neoadj/Adj, Tx Adv Disease |
| | Prior RT | None, Primary tumor, Metastatic Dz |
| | Prior Surgery | Y, N |
| Colorectal | Current Stage | O, I, II, III, IV |
| cancer | Prior Chemo | None, Neoadj/Adj, Tx Adv Disease |
| | Prior RT | None, Primary tumor, Metastatic Dz |
| | Prior Surgery | Y, N |
| Prostate | Metastases | Y, N |
| cancer | Primary | N/A, T0, T1a, T1b, T1c, |
| | Tumor | T2 (T2a, T2b), T3 (T3a, T3b), T4 |
| | Nodes | N/A, N0, N1 |
| | Prior Chemo | None, Neoadj/Adj, Tx Adv Disease |
| | Prior RT | None, Primary tumor, Metastatic Dz |
| | Prior Surgery | Y, N |
| | Prior | None, Neoadj/Adj, Tx Adv Disease |
| | Hormonal | |

In the embodiment illustrated by Table I, the designer encodes preliminary eligibility criteria by assigning one of the available choices to each of at least a subset of the attributes in the selected list. Each “criterion” is defined by an attribute and its assigned value, so that a patient satisfies the criterion only if the patient has the specified value for that attribute. Each criterion is then classified either as an “inclusion” criterion or an “exclusion” criterion; a patient must satisfy all the inclusion criteria and none of the exclusion criteria in order to pass preliminary eligibility.

The logic of the preliminary eligibility criteria is capable of many variations in different embodiments. Speaking generally, each criterion is defined by an attribute and a “condition”, and the patient must satisfy the condition with respect to that attribute in order to satisfy the criterion.

The overall clinical trials process illustrated in FIG. 1 is performed by a wide variety of different people, all of whom might have different understandings about the meaning of various concepts, terms and attributes. Therefore, in order for all the different steps and tools to work well together, the system of FIG. 1 takes advantage of a Controlled Medical Terminology (CMT) 112 wherever possible. For example, most if not all of the concepts, terms and attributes which are used in the workflow task building blocks and patient eligibility criteria options made available in the meta-models produced in step 110, are entries in the CMT 112.

The step 110 of creating protocol meta-models is performed using a meta-model authoring tool. Protégé 2000 is an example of a tool that can be used as a meta-model authoring tool. Protégé 2000 is described in a number of publications including William E. Grosso, et. al., “Knowledge Modeling at the Millennium (The Design and Evolution of Protégé -2000),” SMI Report Number: SMI-1999-0801 (1999), available at http://smi-web.stanford.edu/ pubs/SMI_Abstracts/SMI-1999-0801 .html, visited Jan. 1, 2000, incorporated by reference herein. In brief summary, Protégé 2000 is a tool that helps users build other tools that are custom-tailored to assist with knowledge-acquisition for expert systems in specific application areas. It allows a user to define “generic ontologies” for different categories of endeavor, and then to define “domain-specific ontologies” for the application of the generic ontology to more specific situations. In many ways, Protégé 2000 assumes that the different generic ontologies differ from each other by major categories of medical endeavors (such as medical diagnosis versus clinical trials), and the domain-specific ontologies differ from each other by disease category. In the present embodiment, however, all ontologies are within the category of medical endeavor known as clinical trials and protocols. The different generic ontologies correspond to the different meta-models produced in step 110 (FIG. 1), which differ from each other by disease category. In this sense, the generic ontologies produced by Protégé in step 110 are directed to a much more specific domain than those produced in other applications of Protégé 2000.

Since the meta-models produced in step 110 include numerous building blocks as well as many options for patient eligibility criteria, a wide variety of different kinds of clinical trial protocols, both simple and complex, can be designed. These meta-models are provided to clinical trial protocol designers who use them, preferably again with the assistance of Protégé 2000, to design individual clinical trial protocols in step 114.

In step 114 of FIG. 1, a protocol designer desiring to design a protocol for a clinical trial in a particular disease category, first selects the appropriate meta-model and then uses the authoring tool to design and store the protocol. As in step 110, one embodiment of the authoring tool for step 114 is based on Protégé 2000. The output of step 114 is a database which contains all the significant required elements of a protocol. This database is sometimes referred to herein as an Intelligent Clinical Protocol (iCP) database, and provides the underlying logical structure for driving much of the processes that take place in the remainder of FIG. 1.

Conceptually, an iCP database is a computerized data structure that encodes most significant operational aspects of a clinical protocol, including eligibility criteria, randomization options, treatment sequences, data requirements, and protocol modifications based on patient outcomes or complications. The iCP structure can be readily extended to encompass new concepts, new drugs, and new testing procedures as required by new drugs and protocols. The iCP database is used by most software modules in the overall system to ensure that all protocol parameters, treatment decisions, and testing procedures are followed.

The iCP database can be thought of as being similar to the CAD/CAM tools used in manufacturing. For example, a CAD/CAM model of an airplane contains objects which represent various components of an airplane, such as engines, wings, and fuselage. Each component has a number of additional attributes specific to that component—engines have thrust and fuel consumption; wings have lift and weight. By constructing a comprehensive model of an airplane, numerous different types of simulations canbe executed using the same model to ensure consistent results, such as flight characteristics, passenger/revenue projections, maintenance schedules. And finally, the completed CAD/CAM simulations automatically produced drawings and manufacturing specifications to accelerate actual production. While an iCP database differs from the CAD/CAM model in important ways, it too provides a comprehensive model of a clinical protocol so as to support consistent tools created for problems such as accrual, patient screening and workflow management. By using a comprehensive model and a unifying standard vocabulary, all tools behave according to the protocol specifications.

As used herein, the term “database” does not necessarily imply any unity of structure. For example, two or more separate databases, when considered together, still constitute a “database” as that term is used herein.

The iCP data structures can be used by multiple tools to ensure that the tool performs in strict compliance with the clinical protocol requirements. For example, a patient recruitment simulation tool can use the eligibility criteria encoded into an iCP data structure, and a workflow management tool uses the visit-specific task guidelines and data capture requirements encoded into the iCP data structure. The behavior of all such tools will be consistent with the protocol because they all use the same iCP database.

Many clinical systems provide a “dumb database” for patient data, but offer no intelligence, no automation. While these systems may offer some efficiency benefits compared to paper systems, they are incapable of driving workflow management, sophisticated data validation or recognizing protocol-critical patterns in patient data (e.g. a toxic response to a drug that should trigger a modification to the treatment). A few systems have used rule-based expert systems or other technologies to deliver more intelligence to clinicians, but these have encountered significant problems: huge up-front modeling costs and ongoing maintenance costs; unpredictable system behavior over time; and an inability to reuse knowledge content or software components. So the choices available for clinical investigators have been poor: use paper, use an electronic file cabinet with no intelligence, or build a custom intelligent system for each trial. The use of an iCP database and a variety of tools designed to be driven by an iCP database overcomes many of the deficiencies with the prior art options.

The iCP database is used to drive all downstream “problem solvers” such as electronic CRF generators, and assures that those applications are revised automatically as the protocol changes. This assures protocol compliance. The iCP authoring tool draws on external knowledge bases to help trial designers, and makes available a library of re-usable protocol “modules” that can be incorporated in new trials, saving time and cost and enabling a clinical trial protocol design process that is more akin to customization than to the current “every trial unique” model.

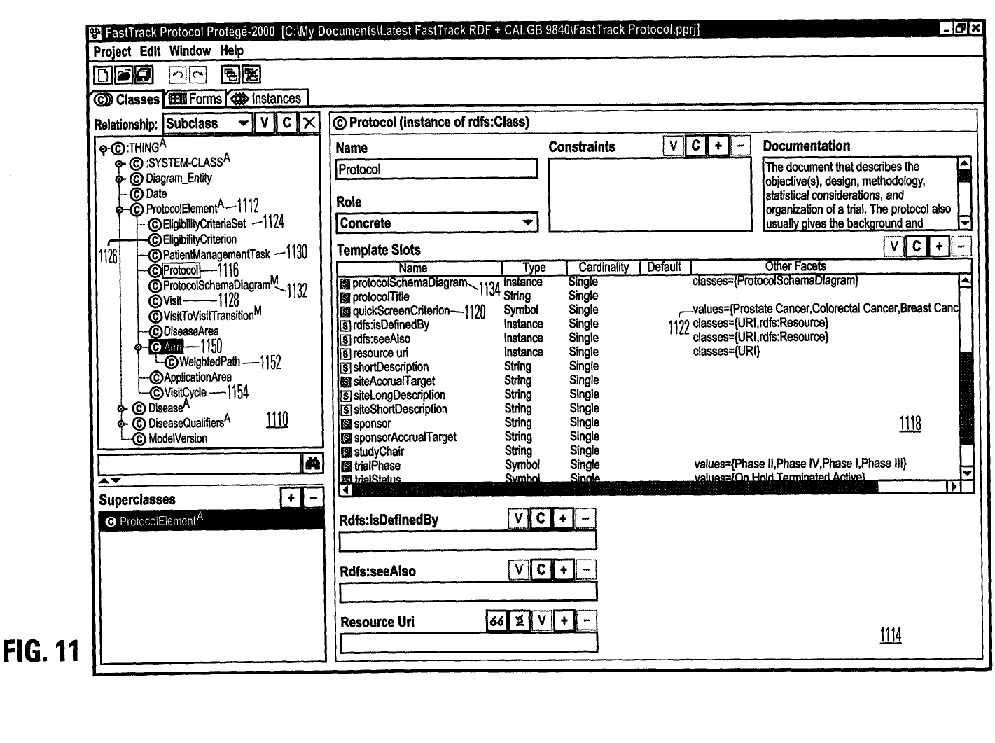

FIGS. 11-25 are screen shots of screens produced by Protégé 2000, and will help illustrate the relationship between a protocol meta-model and an example individual clinical trial protocol. FIG. 11 is a screen shot illustrating the overall class structure in the left-hand pane 1110. Of particular interest to the present discussion is the class 1112, called “ProtocolElement” and the classes under class 1112. ProtocolElement 1112 and those below it represent an example of a protocol meta-model. This particular meta-model is not specific to a single disease category.

The right-hand pane 1114 of the screen shot of FIG. 11 sets forth the various slots that have been established for a selected one of the classes in the left-hand pane 1110. In the image of FIG. 11, the “protocol” class 1116, a subclass of ProtocolElement 1112, has been selected (as indicated by the border). In the right-hand pane 1114, specifically in the window 1118, the individual slots for protocol class 1116 are shown. Only those indicated by a shaded “S” are pertinent to the present discussion; those indicated by an unshaded “S” are more general and not important for an understanding of the invention. It can be seen that several of the slots in the window 1118 contain “facets” which, for some slots, define a limited set of “values” that can be stored in the particular slot. For example, the slot “quickScreenCriterion” can take on only the specific values “prostate cancer,” “colorectal cancer,” “breast cancer,” etc. These are the only disease categories for which quickScreenCriteria had been established at the time the screen shot of FIG. 11 was taken.

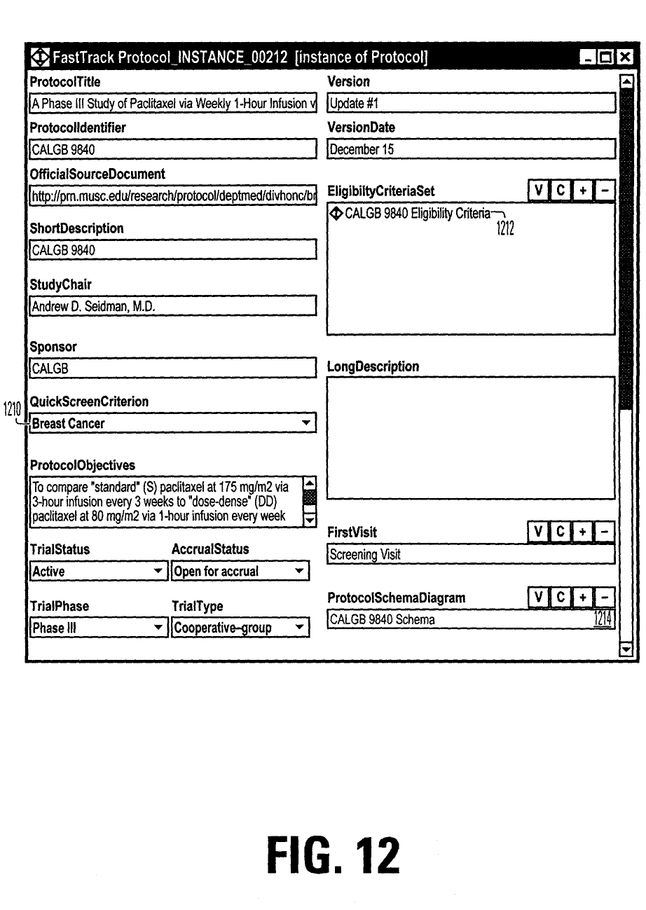

FIG. 12 is a screen shot of a particular instance of class “protocol” in FIG. 11, specifically a protocol object having identifier CALGB 9840. It can be seen that each of the slots defined for protocol class 116 has been filled in with specific values in the protocol class object instance of FIG. 12. Whereas FIG. 11 illustrates an aspect of a clinical trial protocol meta-model, FIG. 12 illustrates the top-level object of an actual iCP designated CALGB 9840. Of particular note, it can be seen that for the iCP CALGB 9840, the slot “quickScreenCriterion” 1120 (FIG. 11) has been filled in by the protocol author as “Breast Cancer” (item 1210 in FIG. 12), which is one of the available values 1122 for the quickScreenCriterion slot 1120 in FIG. 11. In addition, the protocol author has also filled in “CALGB 9840 Eligibility Criteria”, an instance of EligibilityCriteriaSet class 1124, for an EligibilityCriteriaSet slot (not shown in FIG. 11) of the protocol class object. Essentially, therefore, the protocol class object of FIG. 12 includes a pointer to another object identifying the “further eligibility criteria” for iCP CALGB 9840.

As used herein, the “identification” of an item of information does not necessarily require the direct specification of that item of information. Information can be “identified” in a field by simply referring to the actual information through one or more layers of indirection, or by identifying one or more items of different information which are together sufficient to determine the actual item of information.

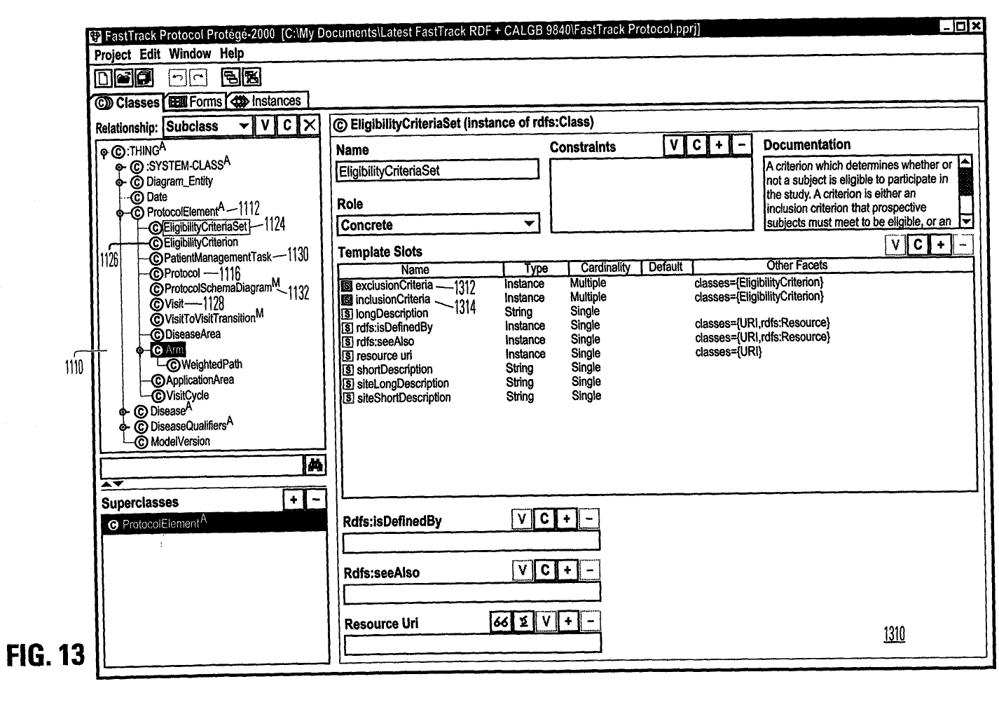

FIG. 13 illustrates in the right-hand pane 1310 the slots defined in the protocol meta-model for the class “EligibilityCriteriaSet” 1124. Of particular note is that an EligibilityCriteriaSet object will include both exclusion criteria (slot 1312) and inclusion criteria (slot 1314). It canbe seen from FIG. 13 that the values that can be placed in slots 1312 and 1314 are objects of the class “EligibilityCriterion” 1126. It will be appreciated that in a different embodiment, other structural organizations for maintaining the same information are possible, such as a single list including all patient eligibility criteria, and flags indicating whether each criterion is an inclusion criterion or an exclusion criterion.

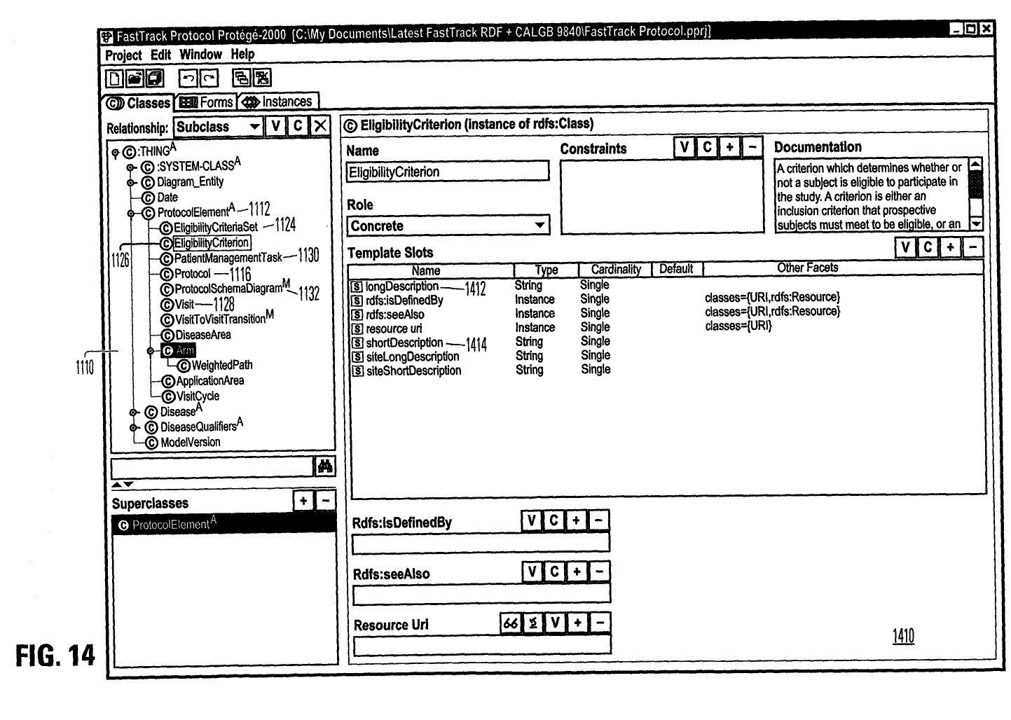

FIG. 14 illustrates in the right-hand pane 1410 the slots which can be filled in for objects of the class “EligibilityCriterion”. As can be seen, these slots are merely for descriptive text strings, primarily a slot 1412 for a long description and a slot 1414 for a short description.

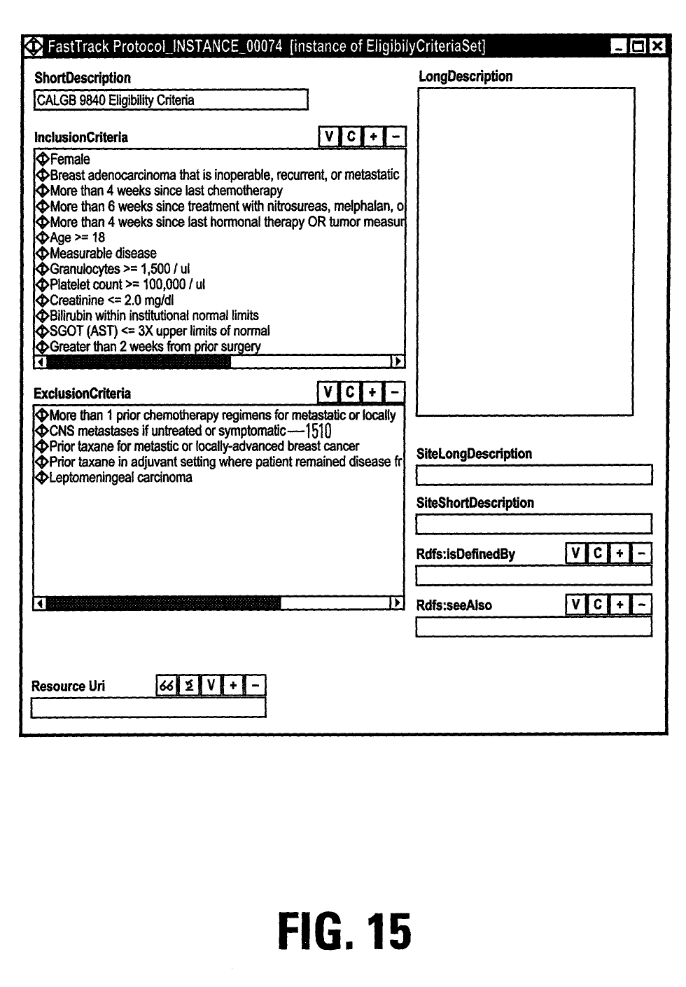

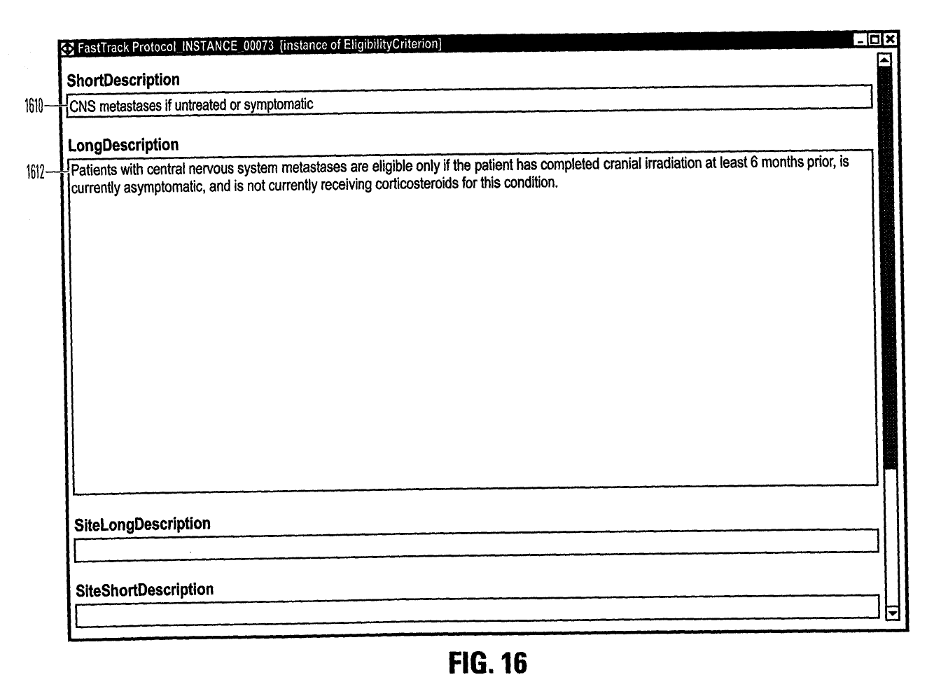

FIG. 15 illustrates the instance of the EligibilityCriteriaSet class which appears in the CALGB 9840 iCP. It can be seen that the object contains a list of inclusion criteria and a list of exclusion criteria, each criterion of which is an instance of the ElgibilityCriterion class 1126. One of such instances 1510 is illustrated in FIG. 16. Only the short description 1610 and the long description 1612 have been entered by the protocol author.

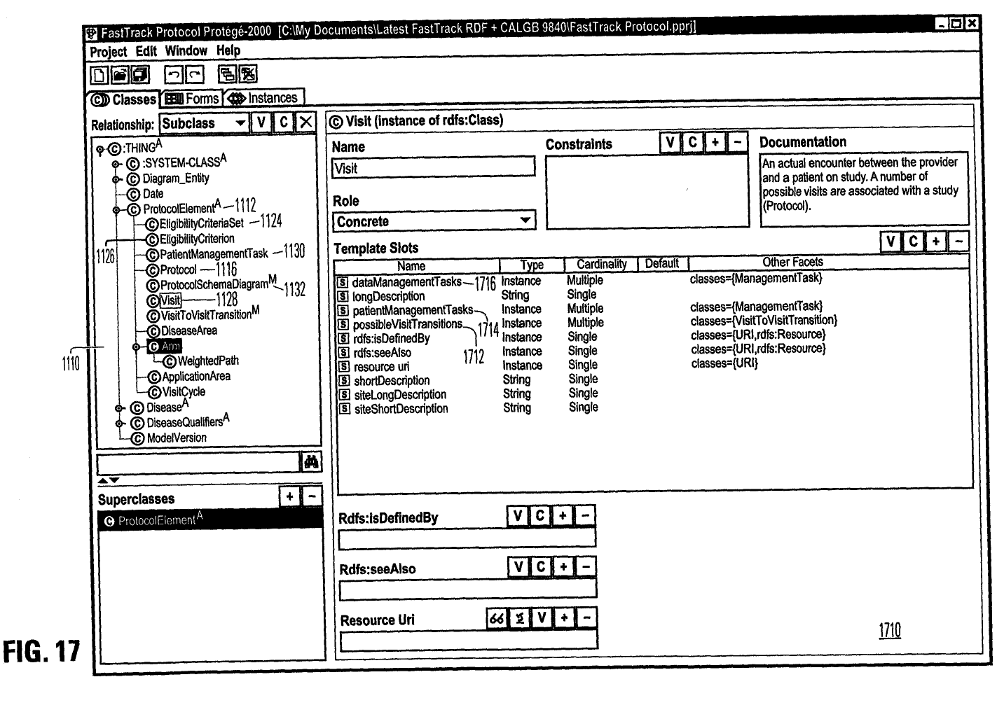

An iCP, in addition to containing a pointer (1210 in FIG. 12) to the relevant set of quickScreenCriteria, and also identifying (1212) further eligibility criteria, also contains the protocol workflow in the form of patient visits, management tasks to take place during a visit, and transitions from one visit to another. The right-hand pane 1710 of FIG. 17 illustrates the slots available for an object instance of the class “visit” 1128. It can be seen that in addition to a slot 1712 for possible visit transitions, the Visit class also includes a slot 1714 for patient management tasks as well as another slot 1716 for data management tasks. In other words, a clinical trial protocol prepared using, this clinical trial protocol meta-model can include instructions to clinical personnel not only for patient management tasks (such as administer certain medication or take certain tests), but also data management tasks (such as to complete certain CRFS).

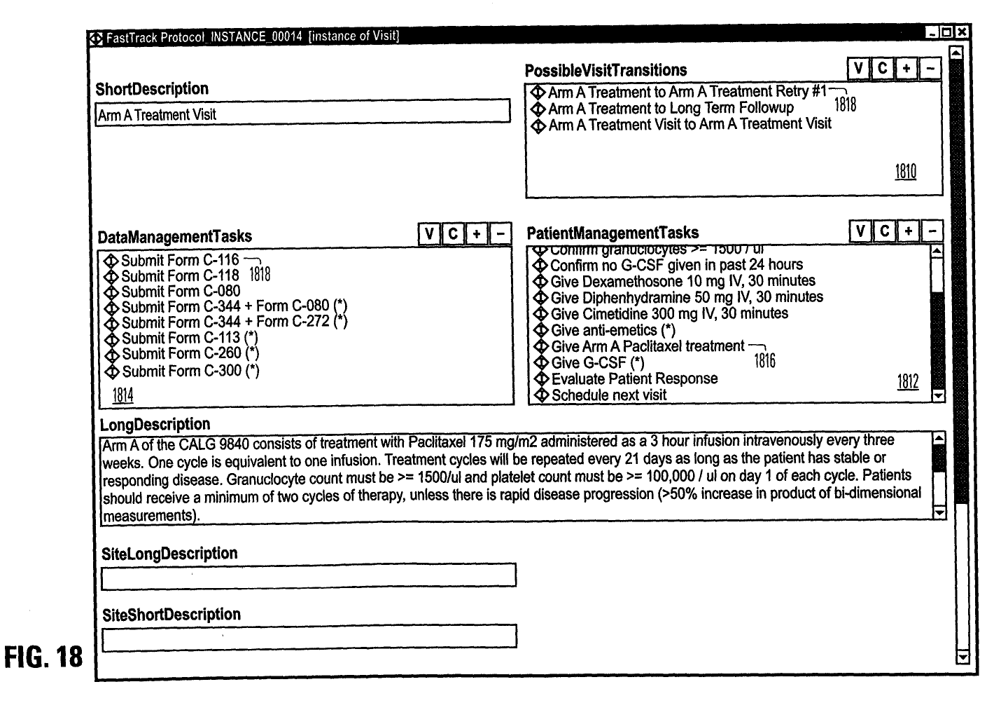

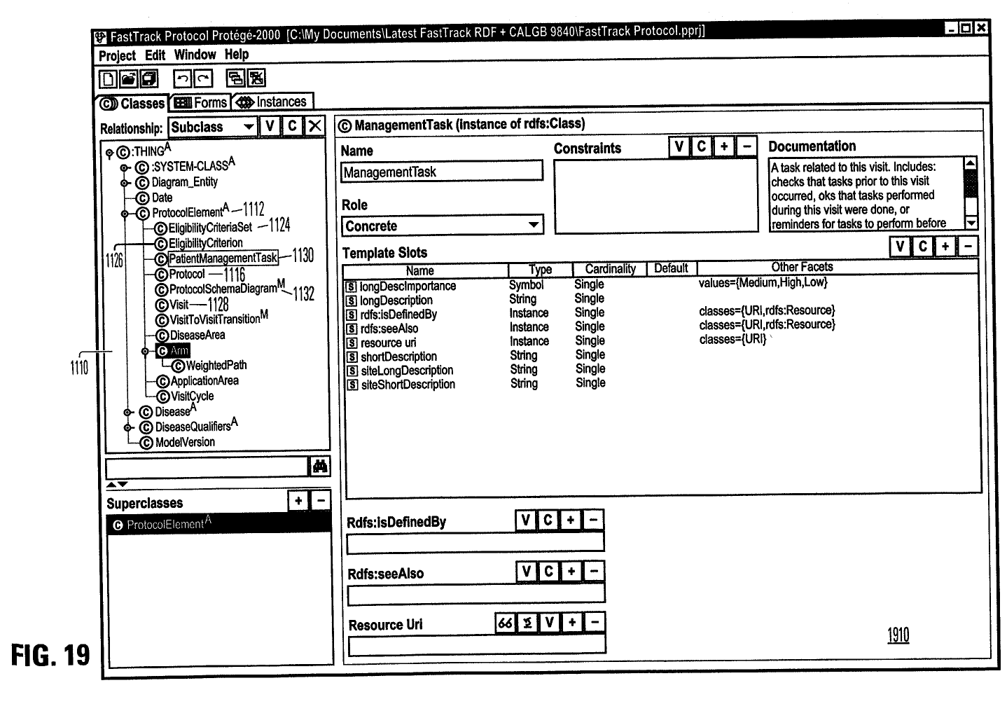

FIG. 18 illustrates a particular instance of visit class 1128, which is included in the CALGB 9840 iCP. As can be seen, it includes a window 1810 containing the possible visit transitions, a window 1812 containing the patient management tasks, and a window 1816 showing the data management tasks for a particular visit referred to as “Arm A treatment visit”. The data management tasks and patient management tasks are all instance of the “PatientManagementTask” class 1130 (FIG. 11), the slots of which are set forth in the right-hand pane 1910 of FIG. 19. As with the EligibilityCriterion class 1126 (FIG. 14), the slots available to a protocol author in a PatientManagementTask object are mostly text fields.

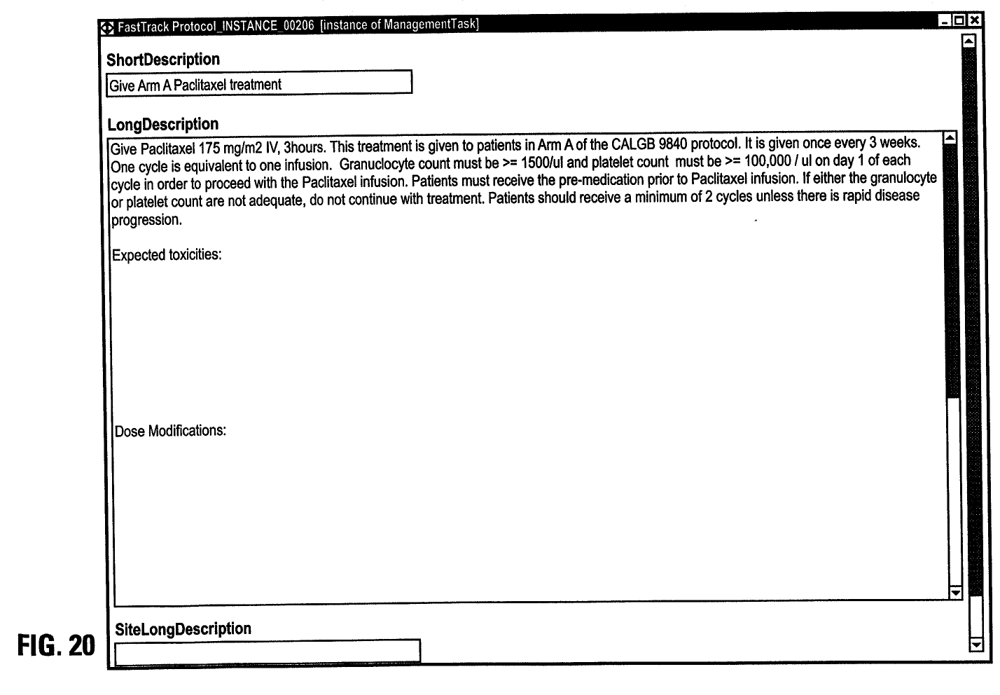

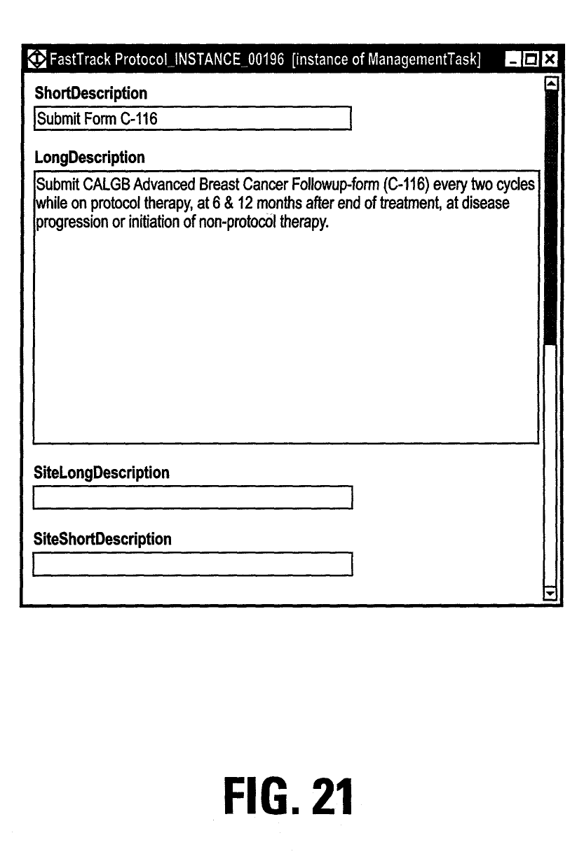

FIG. 20 illustrates the PatientManagementTaskobject 1816 (FIG. 18), “GiveArm APaclitaxelTreatment.” Similarly, FIG. 21 illustrates the PatientManagementTask object 1818, “Submit Form C-116”. The kinds of data management tasks which can be included in an iCP according to the clinical trial protocol meta-model include, for example, tasks calling for clinical personnel to submit a particular form, and a task calling for clinical personnel to obtain informed consent.

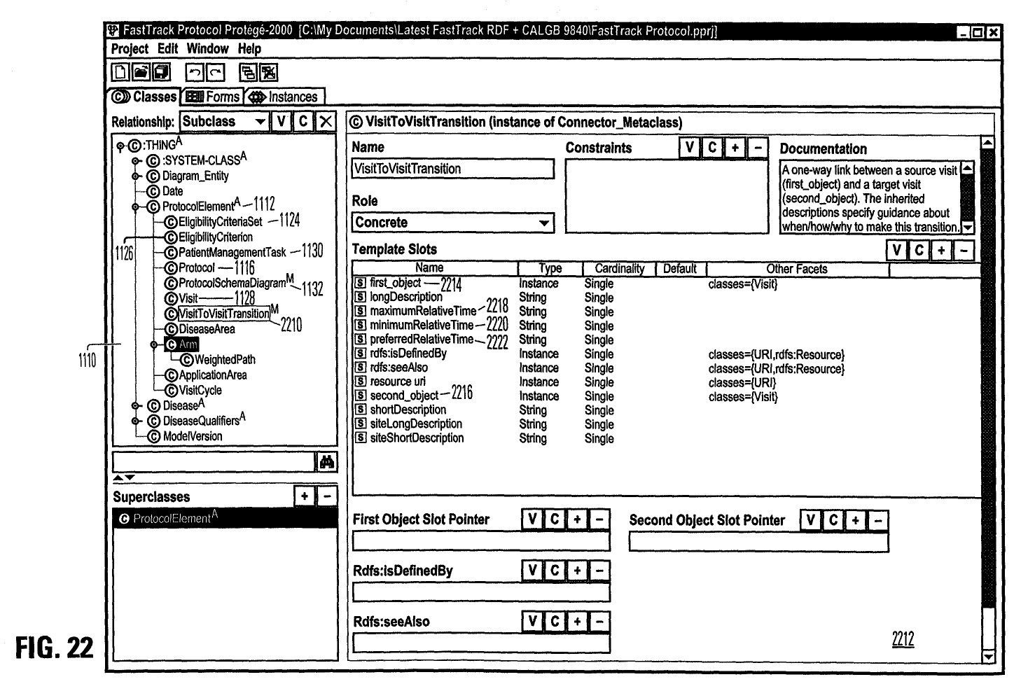

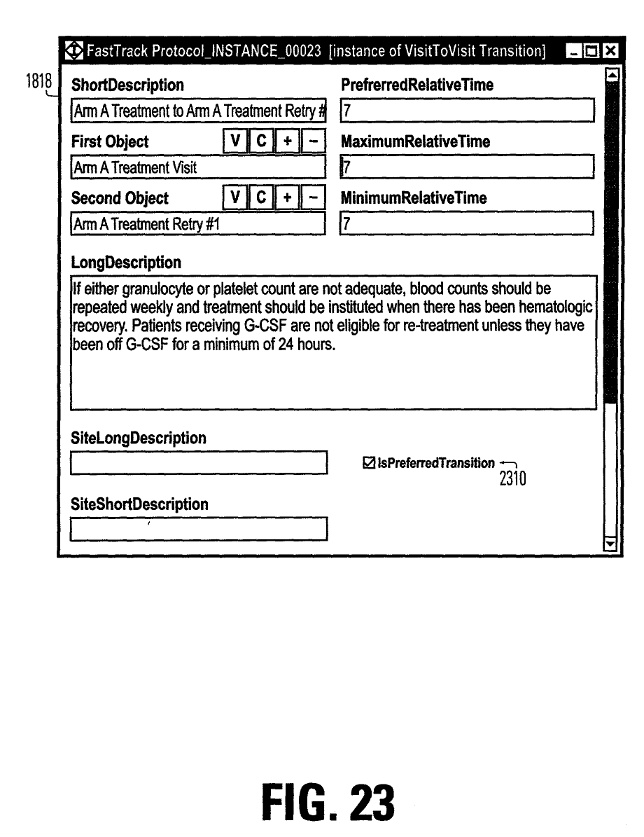

Returning to FIG. 17, the values that a protocol author places in the slot 1712 of a visit class 1128 object are themselves instances of VisitToVisitTransition class 2210 (FIG. 22) in the meta-model. The right-hand pane 2212 shows the slots which are available in an object of the VisitToVisitTransition class 2210. As can be seen, it includes a slot 2214 which points to the first visit object of the transition, another slot 2216 which points to a second visit object of the transition, and three slots 2218, 2220 and 2222 in which the protocol author provides the minimum, maximum and preferred relative time of the transition. FIG. 23 shows the contents of a VisitToVisitTransition object 1818 (FIG. 18) in the CALGB 9840 iCP. The checkbox 2310, labeled “IsPreferredTransition”, is described hereinafter.

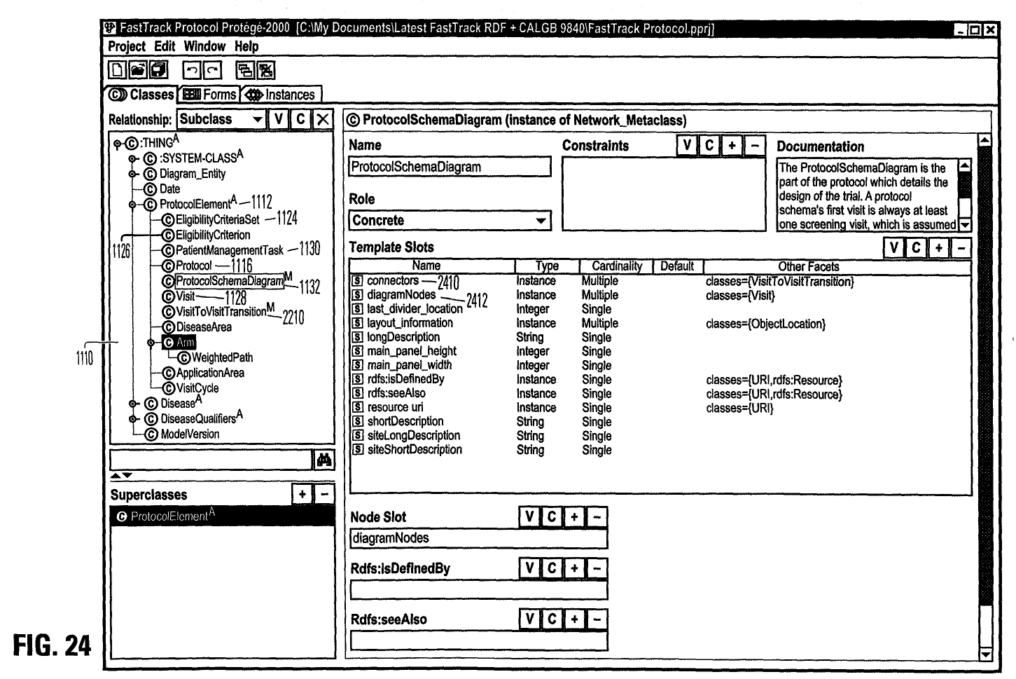

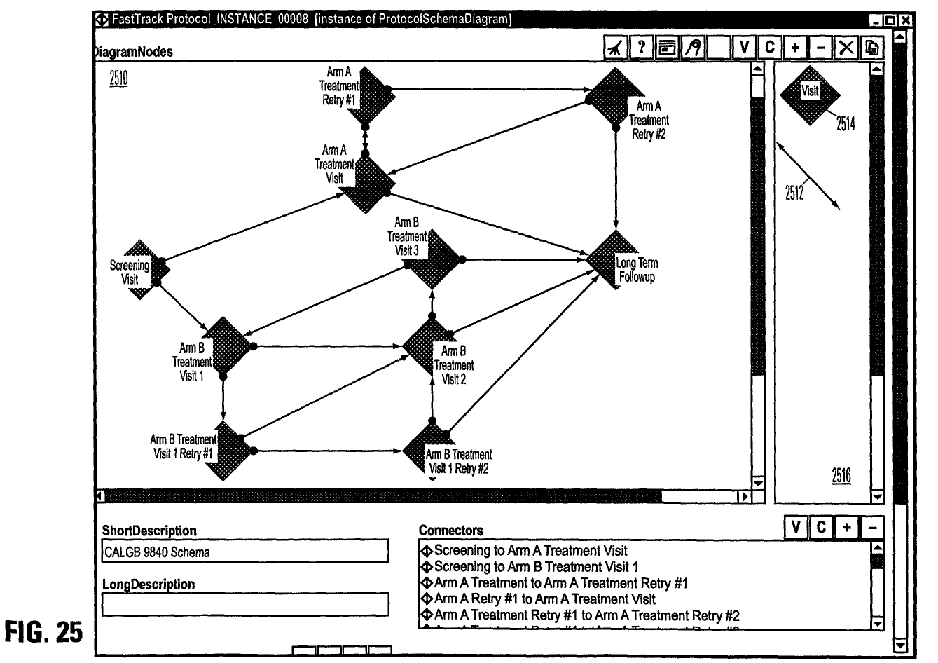

In addition to being kept in the form of Visit objects, management task objects and VisitToVisitTransition objects, the protocol meta-model also allows an iCP to keep the protocol schema in a graphical or diagrammatic form as well. In fact, it is the graphical form that protocol authors typically use, with intuitive drag-and-drop and drill-down behaviors, to encode clinical trial protocols using Protégé 2000. In the protocol meta-model, a slot 1134 is provided in the Protocol object class 1116 for pointing to an object of the ProtocolSchemaDiagram class 1132 (FIG. 11). FIG. 24 shows the slots available for ProtocolSchemaDiagram class 1132. As can be seen, they include a slot 2410 for diagrammatic connectors, and another slot 2412 for diagram nodes. The diagram connectors are merely the VisitToVisitTransition objects described previously, and the diagram nodes are merely the Visit objects described previously. FIG. 25 illustrates the ProtocolSchemaDiagram object 1214 (FIG. 12) in the CALGB 9840 iCP. It can be seen that the entire clinical trial protocol schema is illustrated graphically in pane 2510, and the available components of the graph (connector objects 2512 and visit objects 2514) are available in pane 1516 for dragging to desired locations on the graph.

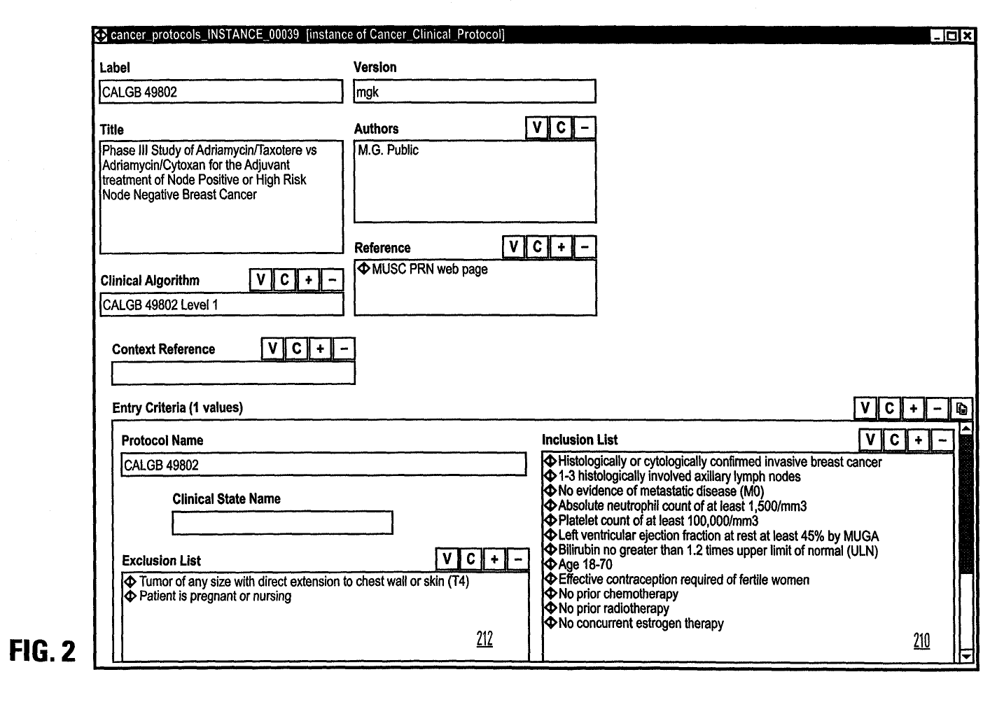

FIGS. 2-8 are screen shots of another example iCP database, created and displayed by Protégé 2000 as an authoring tool. This iCP encodes clinical trial protocol labeled CALGB 49802, and differs from the CALGB 9840 iCP in that CALGB 49802 was encoded using a starting meta-model that was already specific to a specific disease area, namely cancer. It will be appreciated that in other embodiments, the meta-models can be even more disease specific, for example meta-models directed specifically to breast cancer, prostate cancer and so on.

FIG. 2 is a screen shot of the top level of the CALGB 49802 iCP database. The screen shot sets forth all of the text fields of the protocol, as well as a list 210 of patient inclusion criteria and a list 212 of patient exclusion criteria.

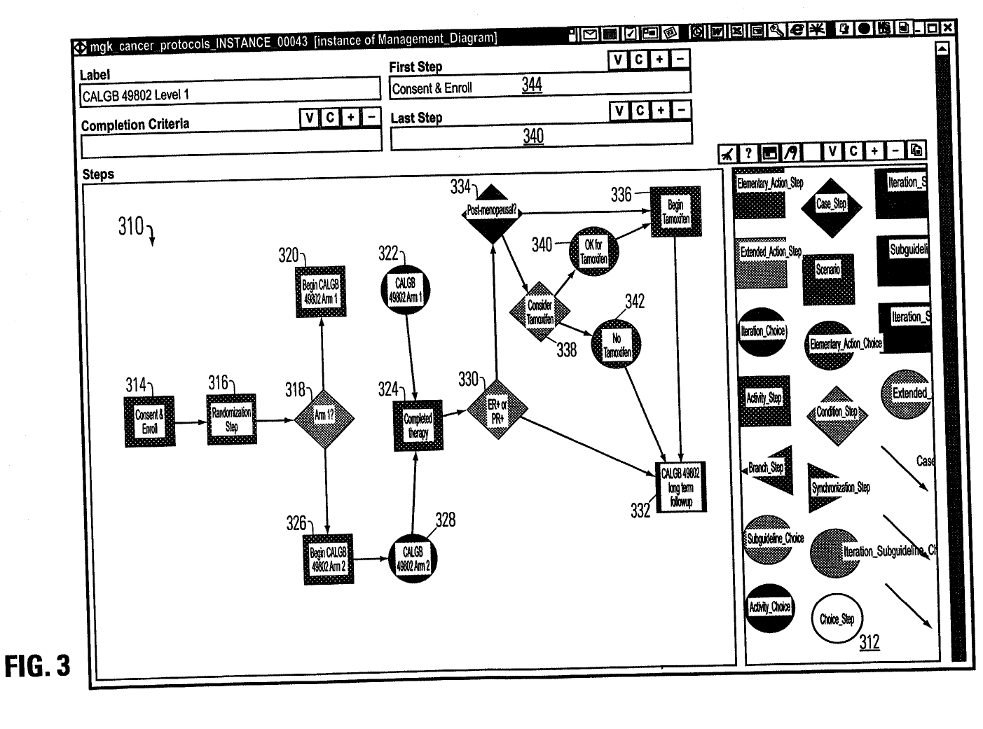

FIG. 3 is a screen shot of the Management_Diagram class object for the iCP, illustrating the workflow diagram for the clinical trial protocol of FIG. 2. The workflow diagram sets forth the clinical algorithm, that is, the sequence of steps, decisions and actions that the protocol specification requires to take place during the course of treating a patient under the particular protocol. The algorithm is maintained as sets of tasks organized as a graph 310, illustrated in the left-hand pane of the screen shot of FIG. 3. The protocol author adds steps and/or decision objects to the graph by selecting the desired type of object from the palate 312 in the right-hand pane of the screen shot of FIG. 3, and instantiating them at the desired position in the graph 310. Buried beneath each object in the graph 310 are fields which the protocol designer completes in order to provide the required details about each step, decision or action. The user interface of the authoring tool allows the designer to drill down below each object in the graph 310 by double-clicking on the desired object. The Management_Diagram object for the iCP also specifies a First Step (field 344), pointing to Consent & Enroll step 314, and a Last Step (field 346), which is blank.

Referring to the graph 310, it can be seen that the workflow diagram begins with a “Consent & Enroll” object 314. This step, which is described in more detail below, includes sub-steps of obtaining patient informed consent, evaluating the patient's medical information against the eligibility criteria for the subject clinical trial protocol, and if all such criteria are satisfied, enrolling the patient in the trial.

After consent and enrollment, step 316 is a randomization step. If the patient is assigned to Arm 1 of the protocol (step 318), then workflow continues with the “Begin CALGB 49802 Arm 1” step object 320. In this Arm, in step 322, procedures are performed according Arm 1 of the study, and workflow continues with the “Completed Therapy” step 324. If in step 318 the patient was assigned Arm 2, then workflow continues at the “Begin CALGB 49802 Arm 2” step 326. Workflow then continues with step 328, in which the procedures of protocol Arm 2 are performed and, when done, workflow continues at the “Completed Therapy” scenario step 324.

After step 324, workflow for all patients proceeds to condition_step “ER+ or PR+” step 330. If a patient is neither estrogen-receptor positive nor progesterone-receptor positive, then the patient proceeds to a “CALGB 49802 long-term follow-up” sub-guideline object step 332. If a patient is either estrogen-receptor positive or progesterone-receptor positive, then the patient instead proceeds to a “Post-menopausal?” condition_step object 334. If the patient is post-menopausal, then the patient proceeds to a “Begin Tamoxifen” step 336, and thereafter to the long-term follow-up sub-guideline 332.

If in step 334, the patient is not post-menopausal, then workflow proceeds to a “Consider Tamoxifen” choice_step object 338. In this step, the physician using clinical judgment determines whether the patient should be given Tamoxifen. If so (choice object 340), then the patient continues to the “Begin Tamoxifen” step object 336. If not (choice object 342), then workflow proceeds directly to the long-term follow-up sub-guideline object 332. It will be appreciated that the graph 310 is only one example of a graph that can be created in different embodiments to describe the same overall protocol schema. It will also be appreciated that the library of object classes 312 could be changed to a different library of object classes, while still being oriented to protocol-directed clinical studies.

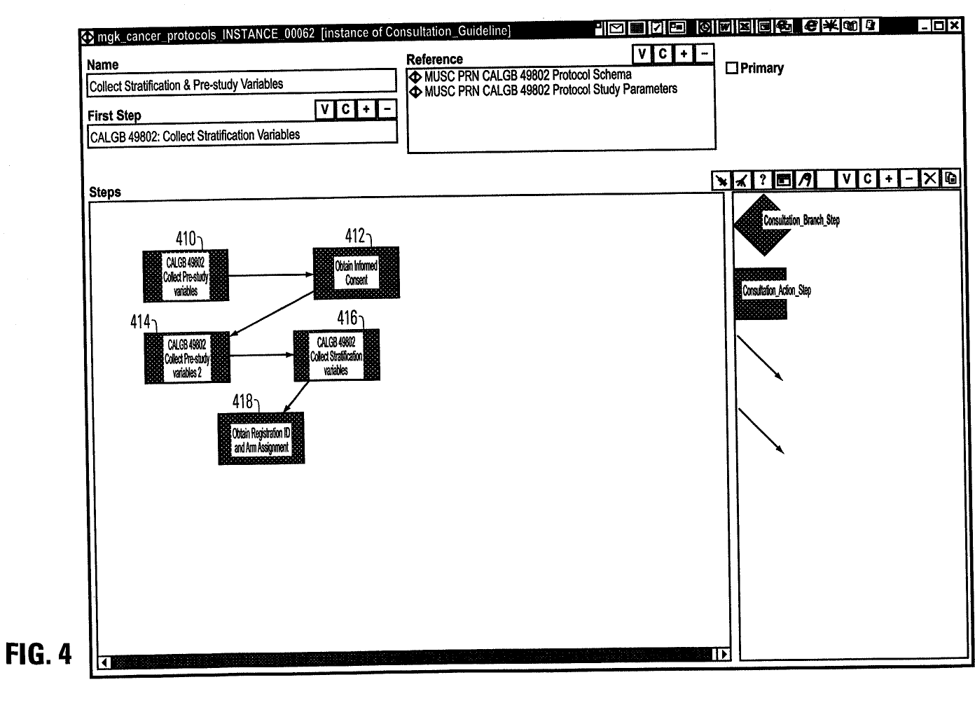

FIG. 4 is a screen shot showing the result of “drilling down” on the “Consent & Enroll” step 314 (FIG. 3). As can be seen, FIG. 4 contains a sub-graph (which is also considered herein to be a “graph” in its own right) 410. The Consent & Enroll step 314 also contains certain text fields illustrated in FIG. 4 and not important for an understanding of the invention.

As can be seen, graph 410 begins with a “collect pre-study variables 1” step object 410, in which the clinician is instructed to obtain certain patient medical information that does not require informed consent. Step 412 is an “obtain informed consent” step, which includes a data management task instructing the clinician to present the study informed consent form to the patient and to request the patient's signature. In another embodiment, the step 412 might include a sub-graph which instructs the clinician to present the informed consent form, and if it is not signed and returned immediately, then to schedule follow-up reminder telephone calls at future dates until the patient returns a signed form or declines to participate.

After informed consent is obtained, the sub-graph 410 continues at step object 414, “collect pre-study variable 2”. This step instructs the clinician to obtain certain additional patient medical information required for eligibility determination. If the patient is eligible for the study and wishes to participate, then the flow continues at step object 416, “collect stratification variables”. The flow then continues at step 418, “obtain registration I.D. and Arm assignment” which effectively enrolls the patient in the trial.

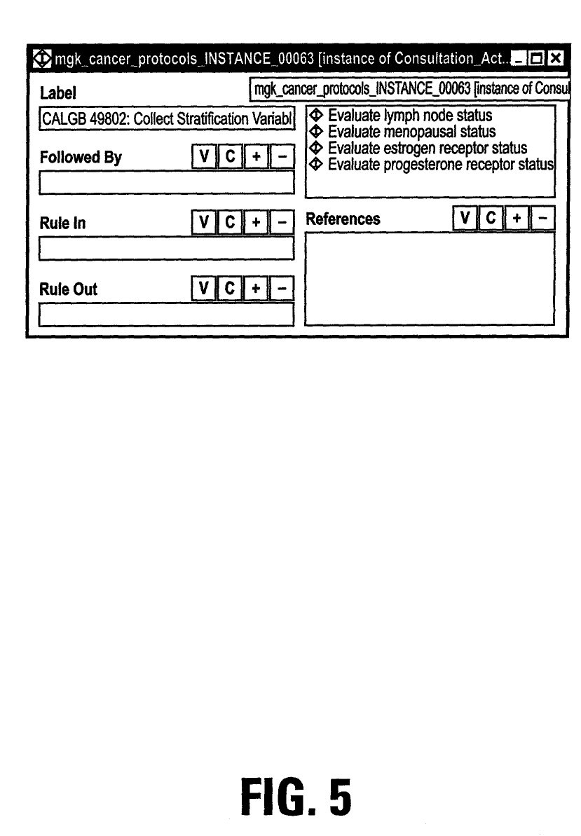

FIG. 5 is a detail of the “Collect Stratification Variables” step 416 (FIG. 4). As can be seen, it contains a number of text fields, as well as four items of information that the clinician is to collect about the subject patient. When the clinical site protocol management software reaches this stage in the workflow, it will ask the clinician to obtain these items of information about the current patient and to record them for subsequent use in the protocol. The details of the “Collect pre-study variables” 1 and 2 steps 410 and 414 (FIG. 4) are analogous, except of course the specific tasks listed are different.

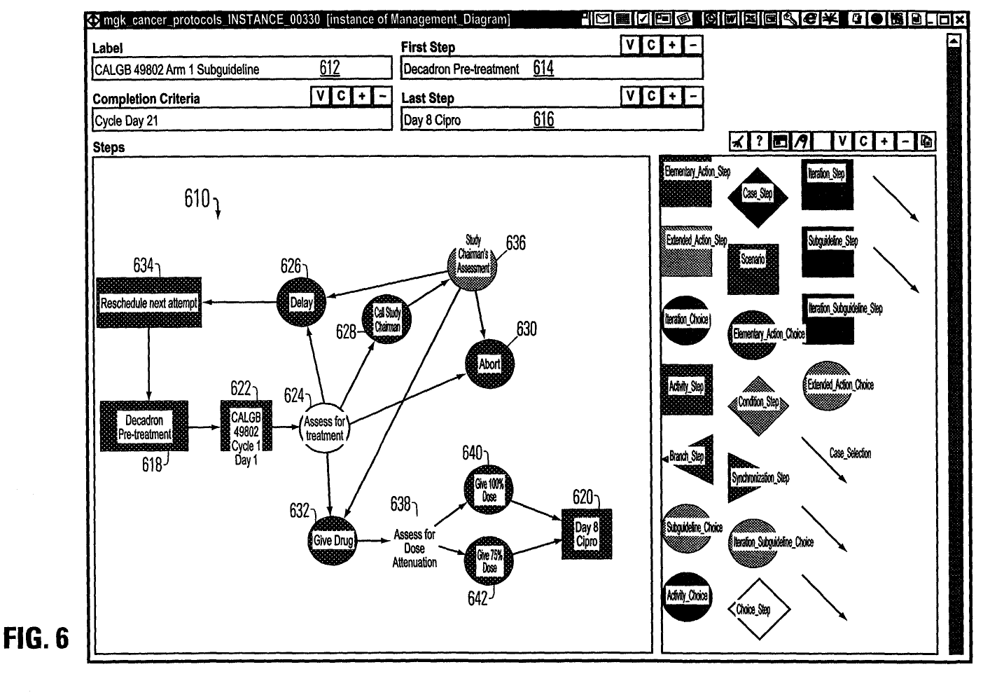

FIG. 6 is a detail of the “CALGB 49802 Arm 1” sub-guideline 332 (FIG. 3). As in FIG. 4, FIG. 6 includes a sub-graph (graph 610) and some additional information fields 612. The additional information fields 612 include, among other things, an indication 614 of the first step 618 in the graph, and an indication 616 of the last step 620 of the graph.

Referring to graph 610, the arm 1 sub-guideline begins with a “Decadron pre-treatment” step object 618. The process continues at a “Cycle 1; Day 1” object 622 followed by a choice_object 624 for “Assess for treatment.” The clinician may make one of several choices during step 624 including a step of delaying (choice object 626); a step of calling the study chairman (choice object 628); a step of aborting the current patient (choice object 630); or a step of administering the drug under study (choice object 632). If the clinician chooses to delay (object 626), then the patient continues with a “Reschedule next attempt” step 634, followed by another “Decadron pre-treatment” step 618 at a future visit. If in step 624 the clinician chooses to call the study chairman (object 628), then workflow proceeds to choose_step object 636, in which the study chair makes an assessment. The study chair can choose either the delay object 626, the “Give Drug” object 632, or the “Abort” object 630.

If either the clinician (in object 624) or the study chair (in object 636) chooses to proceed with the “Give Drug” object 632, then workflow proceeds to choice_step object 638 at which the clinician assesses the patient for dose attenuation. In this step, the clinician may choose to give 100% dose (choice object 640) or to give 75% dose (choice object 642). In either case, after dosing, the clinician then performs “Day 8 Cipro” step object 620. That is, on the 8^{th} day, the patient begins a course of Ciprofloxacin (an antibiotic).

Without describing the objects in the graph 610 individually, it will be understood that many of these objects either are themselves specific tasks, or contain task lists which are associated with the particular step, visit or decision represented by the object.

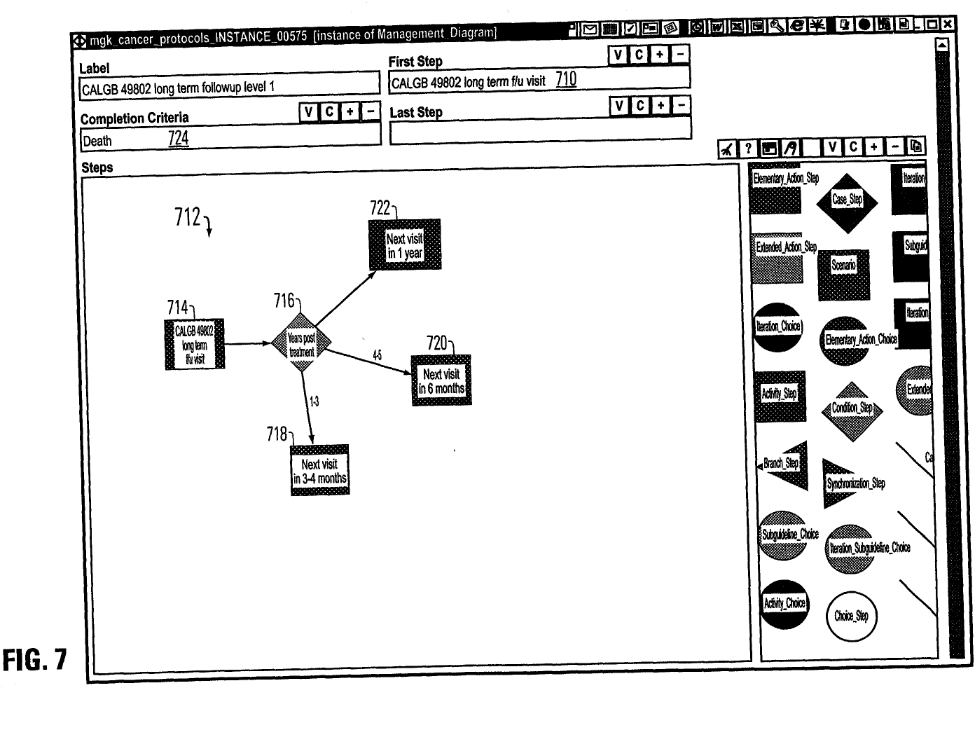

FIG. 7 is a detail of the long term follow-up object 332 (FIG. 3). As mentioned in field 710, the first step in the sub-graph 712 of this object is a long term follow-up visit scenario visit object 714. That is, the sub-guideline illustrated in graph 712 is executed on each of the patient's long-term follow-up visits. As indicated in field 724, the long term follow-up step 332 (FIG. 3) continues until the patient dies.

Object 716 is a case_object which is dependent upon the patient's number of years post-treatment. If the patient is 1-3 years post-treatment, then the patient proceeds to step object 718, which among other things, schedules the next visit in 3-4 months. If the patient is 4-5 years post-treatment, then the patient proceeds to step object 720, which among other things, schedules the next patient visit in 6 months. If the patient is more than 5 years post-treatment, then the patient proceeds to step object 722, which among other things, schedules the next visit in one year. Accordingly, it can be seen that in the sub-guideline 712, different tasks are performed if the patient is less than 3 years out from therapy, 4-5 out from therapy, or more than 5 years out from therapy. Beneath each of the step objects 718, 720 and 722 are additional workflow tasks that the clinician is required to perform at the current visit.

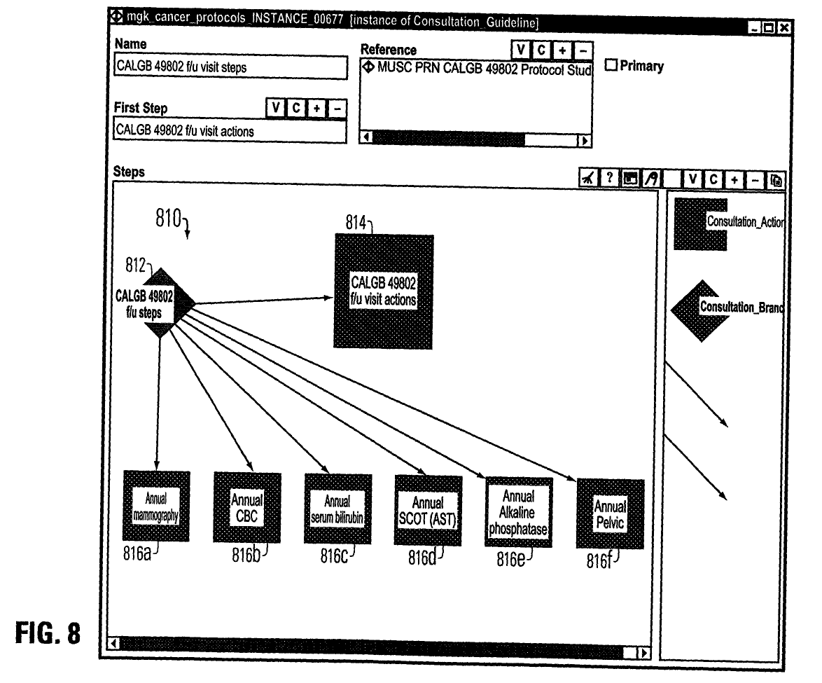

FIG. 8 is an example detail of one of the objects 718, 720 or 722 (FIG. 7). It includes a graph 810 which begins with a CALGB 49802 f/u visit steps consultation_branch object 812, followed by seven elementary_action objects 814 and 816a-f (collectively 816). Each of the consultation_action objects 814 and 816 includes a number of workflow tasks not shown in the figures. It can be seen from the names of the objects, however, that the workflow tasks under object 814 are to be performed at every follow-up visit, whereas the workflow tasks under objects 816 are to be performed only annually.

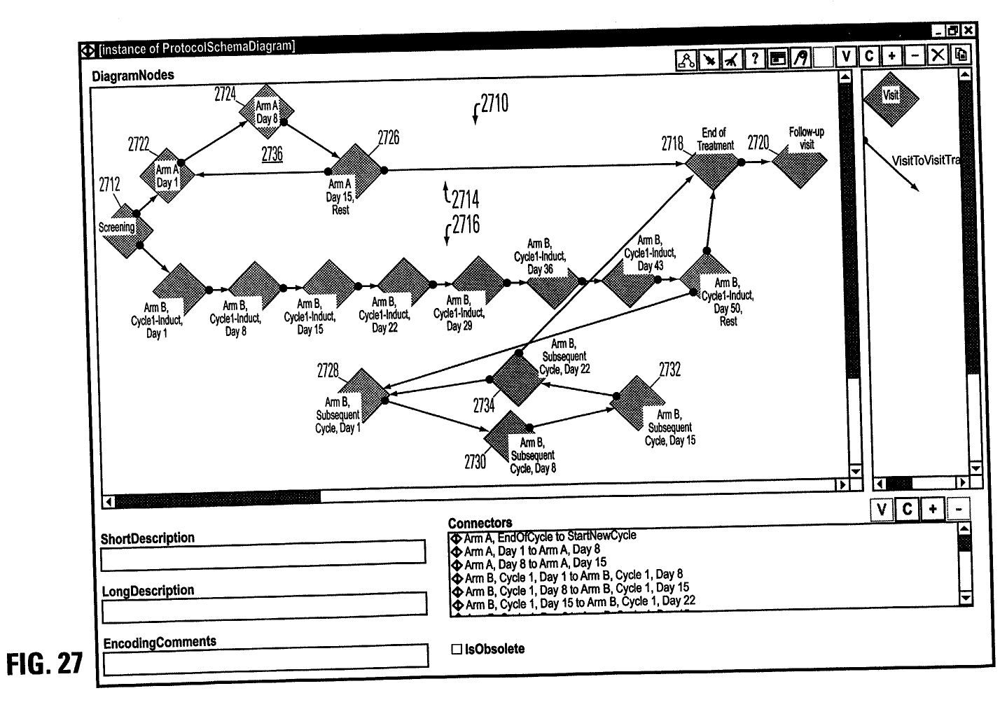

FIGS. 27-33 are screen shots of portions of yet another example iCP database, created and displayed by Protégé 2000 as an authoring tool. FIG. 27 illustrates the protocol schema 2710. It comprises a plurality of Visit objects (indicated by the diamonds), and a plurality of Visit To Visit Transition objects, indicated by arrows. The first Visit object 2712 in this example calls for certain patient screening steps. Following step 2712, the protocol schema 2710 divides into two separate “arms” referred to as Arm A and Arm B 2714 and 2716, respectively. The two arms rejoin at Visit object 2718, entitled “end of treatment.” Following Visit object 2718 is another Visit object 2720, entitled “follow-up visit.” In addition, within Arm A 2714, there are three Visit objects 2722, 2724 and 2726 which form a “cycle” 2736. That is, progress proceeds from object 2722 to object 2724, and then onto object 2726, and then conditionally back to object 2722 for one or more additional repetitions of the sequence. Alternatively, progress from Visit object 2726 can proceed to the “end of treatment” Visit object 2718. Arm B 2716 includes a cycle as well, consisting of Visit objects 2728, 2730, 2732 and 2734.

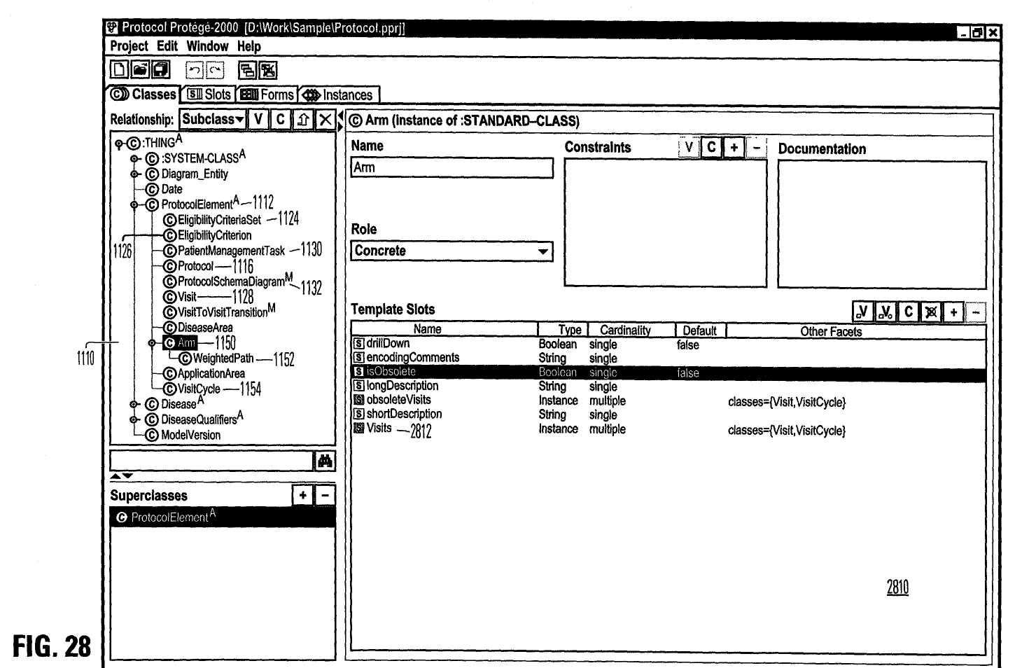

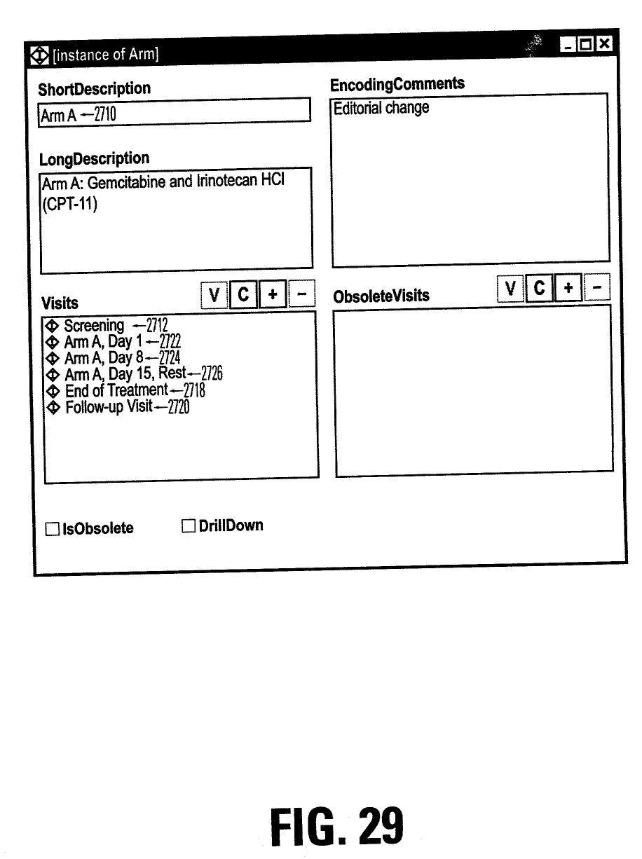

In order to facilitate the generation of a timeline of expected patient progress through the workflow guideline, the class structure includes three additional classes shown in FIG. 11: Arm class 1150, WeightedPath class 1152, and VisitCycle class 1154. FIG. 28 illustrates in the right-hand pane 2810 the slots defined in the protocol meta-model for Arm class 1150. In particular, it can be seen that in slot 2812 and Arm object can include multiple instances of Visit objects and VisitCycle objects. FIG. 29 illustrates the contents of the Arm A instance of Arm object 2710. In the “visits” window, it can be seen that the object points to each of the Visit objects in Arm A 2710 in the protocol schema of FIG. 27, including the Visit objects 2712, 2718 and 2720 which are all common with Arm B.

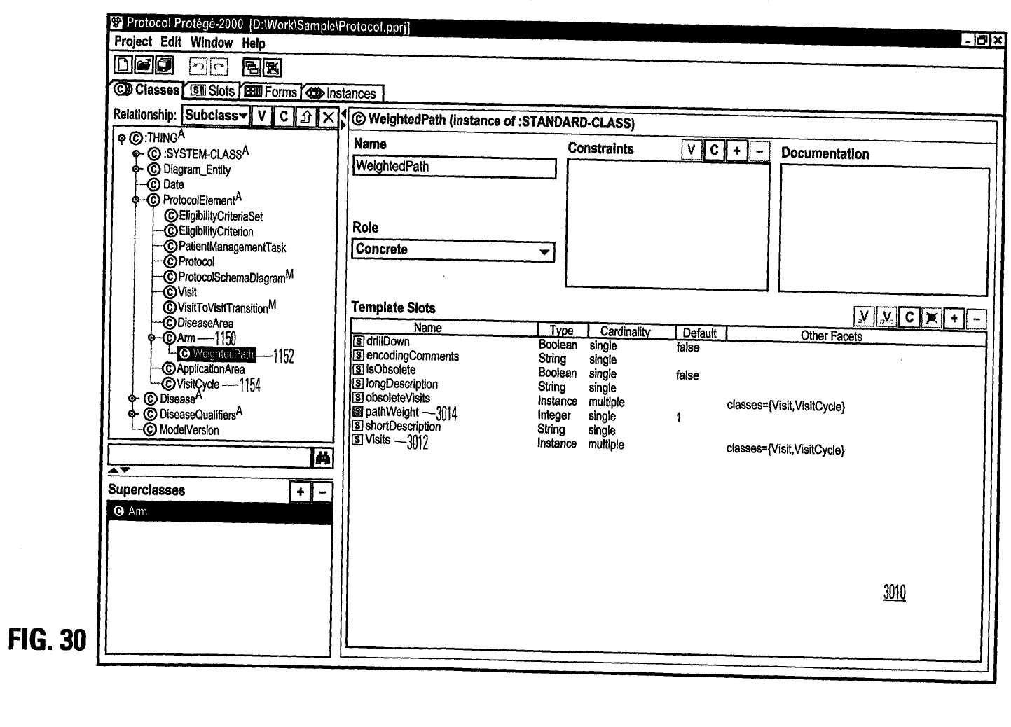

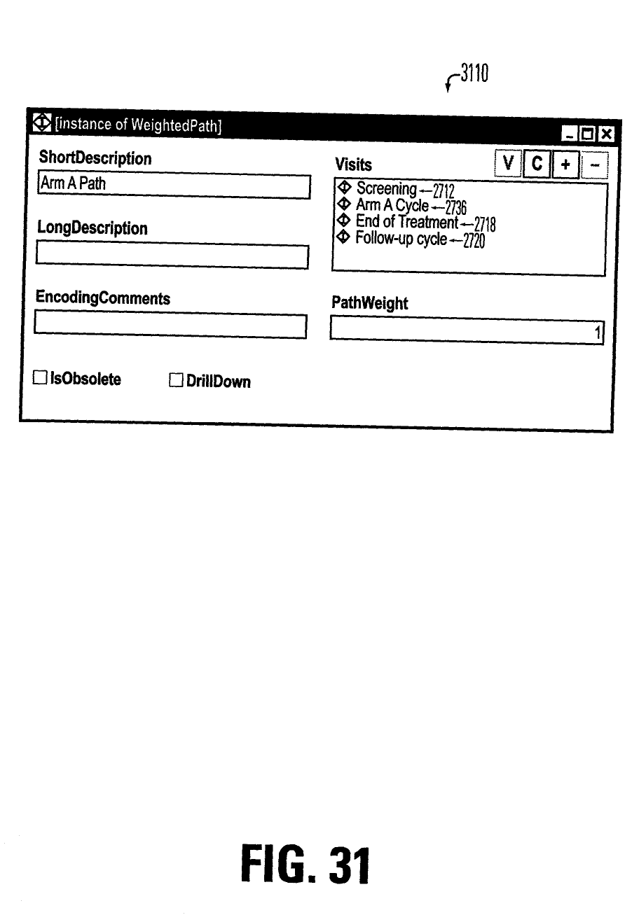

FIG. 30 illustrates in the right hand pane 3010 the slots defined in the protocol meta-model for the class WeightedPath 1152. It can be seen that the WeightedPath class 1152 includes a slot 3012 for Visits, like the Arm class 1150; but also includes a slot 3014 for a path weight value. FIG. 31 illustrates an instance of a WeightedPath object 3110, again corresponding to Arm A 2714 in the protocol schema of FIG. 27. As can be seen, WeightedPath object 3110 includes the Visits 2712, 2718 and 2720, and also includes the Visits 2722, 2724 and 2726 as a single VisitCycle object 2736. WeightedPath object 3110 also includes the integer “1” as the PathWeight.

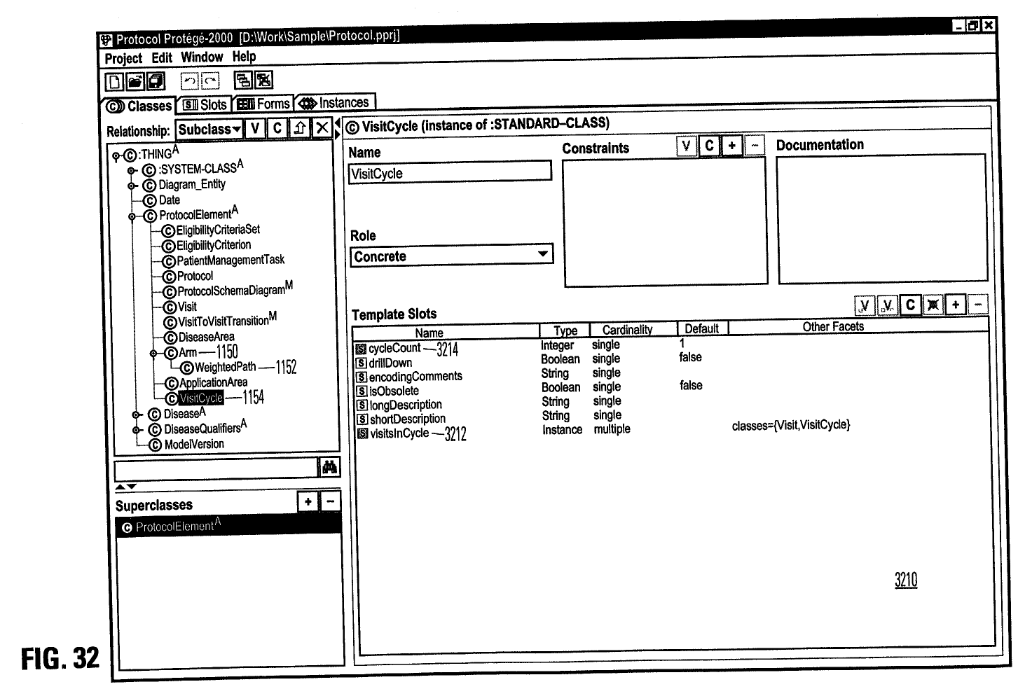

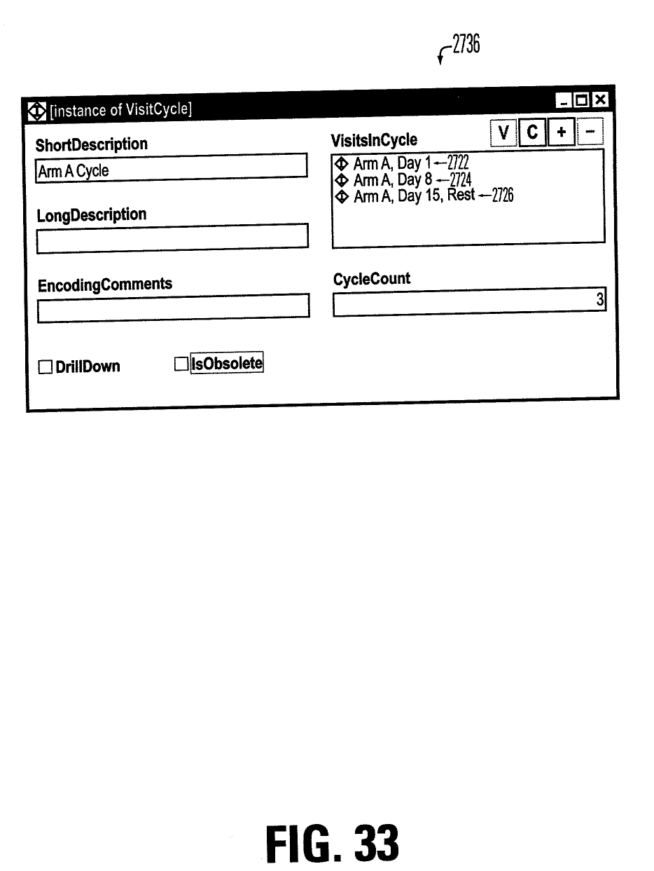

FIG. 32 illustrates in the right-hand pane 3210 the slots defined in the protocol meta-model for the class 1154, VisitCycle. Of particular note is that it includes a slot entitled visitsInCycle 3212, for identifing multiple instances of Visit or VisitCycle class objects. It also includes a slot 3214 for a cycleCount value, indicating the number of times a patient is expected to traverse the cycle. FIG. 33 is a sample instance for VisitCycle 2736 of FIG. 27. As can be seen, it includes the three Visit objects 2722, 2724 and 2726, and it also includes a cycleCount of three.

Returning to FIG. 1, in step 114, the protocol designer uses the authoring tool to encode the eligibility criteria and the protocol schema for the clinical trial being designed. For the protocol schema, the authoring tool creates a graphical tool, called a knowledge acquisition (KA) tool (also considered herein to be part of the protocol authoring tool) that is used by protocol authors to enter the specific features of a clinical trial.

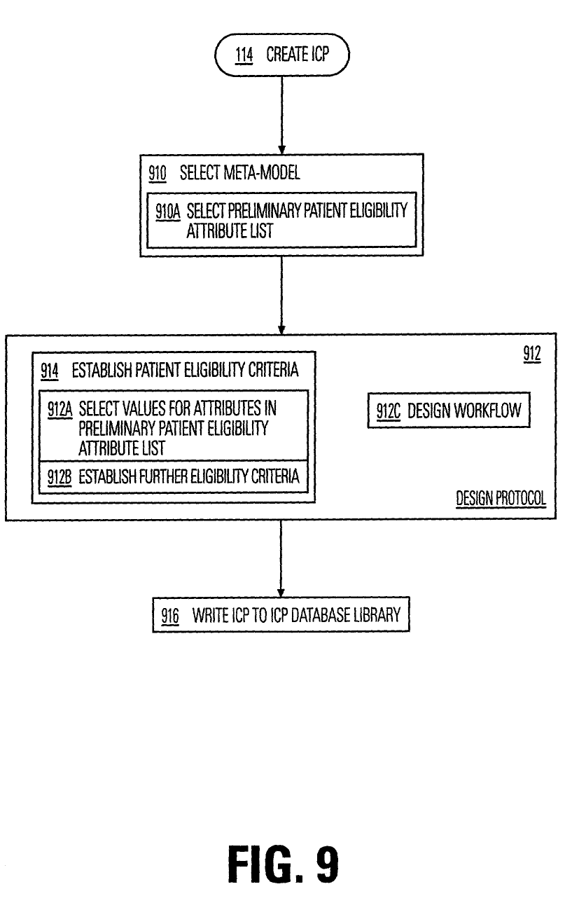

FIG. 9 is a flow chart detail of the step 114 (FIG. 1). In order to create an iCP, in a step 910, the protocol designer first selects the appropriate meta-model provided by the central authority in step 110. In most but not all cases, if the clinical trial protocol under development involves the testing of a particular treatment against a particular disease, then the step of selecting a meta-model involves merely the selection of the meta-model that has been created for the relevant disease category. In addition, in the embodiment described herein, each meta-model contains only a single list of relevant preliminary patient eligibility attributes and attribute choices. The step 910 of selecting a meta-model therefore also accomplishes a step of selecting one of a plurality of pre-existing lists of preliminary patient eligibility attributes. (Step 910A). As used herein, a list of eligibility attributes can be “defined” by a number of different methods, one of which is by “selecting” the list (or part of the list) from a plurality of previously defined lists of eligibility attributes. This is the method by which the list of preliminary patient eligibility attributes is defined in step 910A.

After the protocol author selects a meta-model, in step 912, the author then proceeds to design the protocol. The step 912 is a highly iterative process, and includes a step 912A of selecting values for the individual attributes in the preliminary patient eligibility attributes list; a step 912B of establishing further eligibility criteria for the protocol; and a step 912C of designing the workflow of the protocol. Generally the step 912A of selecting values for attributes in the preliminary patient attribute list will precede step 912B of establishing the further eligibility criteria, and both steps 912A and 912B will precede the step 912C of designing the workflow. However, at any time during the process, the protocol author might go back to a previous one of these steps to revise one or more of the eligibility criteria.

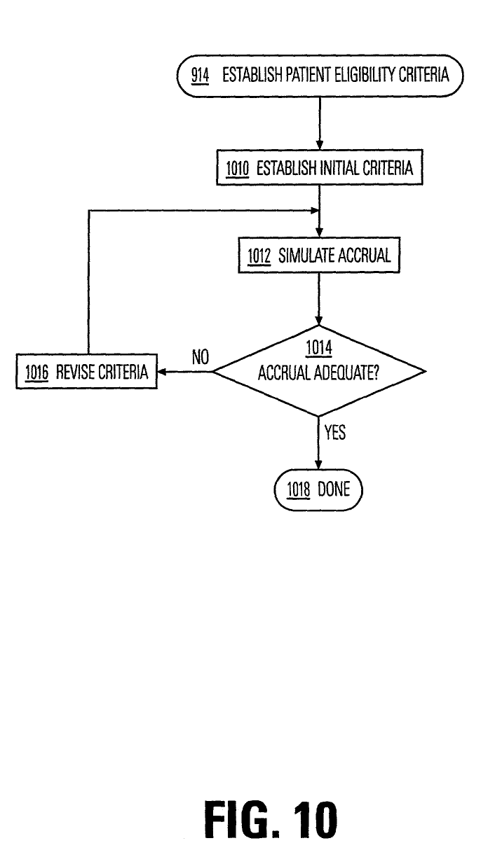

FIG. 10 is a flow chart of an advantageous method for the protocol author to establish the patient eligibility criteria. The protocol author is not required to follow the method of FIG. 10, but as will be seen, this method is particularly advantageous. The method of FIG. 10 is shown as a detail of step 914 (FIG. 9), which includes both the steps of selecting values for preliminary patient eligibility attributes and for establishing further eligibility criteria (steps 912A and 912B), rather than as being a detail of step 912A or 912B specifically, because the method of FIG. 10 can be used in either step above, or in both separately, or in both together.

The method of FIG. 10, sometimes referred to herein as an accrual simulation method for establishing patient eligibility criteria, substantially solves the problem mentioned above in which after finalizing a clinical trial protocol, engaging study sites and beginning the enrollment process, it is finally found that the eligibility criteria for the study are too restrictive and that with such criteria it is not possible to enroll sufficient patients in the trial. As mentioned above, these accrual delays are among the most costly and time consuming problems in clinical trials. The method of FIG. 10 addresses this problem by tapping an existing database of patient characteristics (database 116 in FIG. 1) as many times as necessary during the step 912 of designing the protocol, in order to choose eligibility criteria which are likely to enroll sufficient numbers of patients to make the study worthwhile. Generally the effort is to find ways to broaden some or all of the eligibility criteria just enough to satisfy that need, while maintaining sufficient specificity in the study sample to ensure that the patients being treated are sufficiently similar in respect to clinical conditions, co-existing illnesses, and other characteristics which could modify their response to treatment.

Referring to FIG. 10, in step 1010, the protocol author first establishes initial patient eligibility criteria. Depending on which sub-step(s) of step 914 (FIG. 9) is currently being addressed, this could involve selecting values for the attributes in the previously selected patient eligibility attribute list, or establishing further eligibility criteria, or both. In step 1012, an accrual simulation tool runs the current patient eligibility criteria against the accrual simulation database 116 (FIG. 1), and returns the number or percentage of patients in the database who meet the specified criteria. If the database includes a field specifying each patient's location, then the authoring tool can also return an indication of which clinical sites are likely to be most fruitful in enrolling patients.

In one embodiment, the accrual simulation database includes one or more externally provided patient-anonymized electronic medical records databases. In another embodiment, it includes patient-anonymized data collected from various clinical sites which have participated in past studies. In the latter case the patient-anonymized data typically includes data collected by the site during either preliminary eligibility screening, further eligibility screening, or both. Preferably the database includes information about a large number of anonymous patients, including such information as the patient's current stage of several different diseases (including the possibility in each case that the patient does not have the disease); what type of prior chemotherapy the patient has undergone, if any; what type of prior radiation therapy the patient has undergone; whether the patient has undergone surgery; whether the patient has had prior hormonal therapy; metastases; and the presence of cancer in local lymph nodes. Not all fields will contain data for all patients. Preferably, the fields and values in the accrual simulation database 116 are defined according to the same CMT 112 used in the protocol meta-models and preliminary and further eligibility criteria. Such consistency of data greatly facilitates automation of the accrual simulation step 1012. Note that since the patients included in the accrual simulation database may be different from and may not accurately represent the universe of patients from which the various clinical sites executing the study will draw, some statistical correction of the numbers returned by the accrual simulation tool may be required to more accurately predict accrual.

After accrual is simulated with the patient eligibility criteria established initially in step 1010, then in step 1014, the protocol author decides whether accrual under those conditions will be adequate for the purposes of the study. If not, then in step 1016, the protocol author revises the patient eligibility criteria, again either the values in the preliminary patient eligibility criteria list or in the further eligibility criteria or both, and loops back to try the accrual simulation step 1012 again. The process repeats iteratively until in step 1014 the protocol author is satisfied with the accrual rate, at which point the step of establishing patient eligibility criteria 914 is done (step 1018).

In an alternative implementation, the accrual simulation step 1012 is implemented not by querying a preexisting database, but rather by polling clinical sites with the then-current eligibility criteria. Such polling can take place electronically, such as via the Internet. Each site participating in the polling responds by completing a return form, either manually or by automatically querying a local database which indicates the number of patients that the site believes it can accrue who satisfy the indicated criteria. The completed forms are transmitted back to the authoring system, which then makes them available to the protocol author for review. The authoring system makes them available either in raw form, or compiled by clinical site or by other grouping, or merely as a single total. The process then continues with the remainder of the flow chart of FIG. 10.

Returning to FIG. 9, both of the steps 912A and 912B preferably take advantage of concepts, terms and attributes already described in the CMT 112 (FIG. 1). The author may use a CMT browser for this purpose, which can either be built into the authoring tool, or a separate application from which the author may cut and paste into the authoring tool. In addition to the literal concept, terms and attributes entries, the CMT 112 preferable also contains “screen questions”, which are more descriptive than the actual entries names themselves, and which help both the protocol author and subsequent users of protocol to interpret each entry consistently.

The step 912C of designing the workflow, results in a graph like those shown in FIGS. 3, 4, 6, 7 and 8 described above. As noted above, the authoring tool allows the protocol author to define not only patient management tasks, but also data management tasks. Such data management tasks can include such items as obtaining informed consent, completing forms regarding patient visits that have taken place, entering workflow progress data (e.g. confirmation that each patient management task identified for a particular visit was in fact performed; and which arm of a branch the patient has taken), and patient medical status information (e.g., patient assessment observations). In addition, preferably the concepts, terms and attributes used in the workflow graph make reference to entries in the CMT database 112. Even more preferably, as in the patient eligibility criteria, the authoring tool enforces reference to a CMT for all concepts, terms and attributes used in the workflow tasks. Again, a CMT browser may be used.

The result of step 912 is an iCP database, such as the one described above with respect to FIGS. 2-8. As can be seen, the iCP contains both eligibility criteria and workflow tasks organized as a graph. The workflow tasks include both patient management tasks and data management tasks, and either type can be positioned on the graph for execution either pre- or post-enrollment.

In step 916, the iCP is written to an iCP database library 118 (FIG. 1), which can be maintained by the central authority. The iCP database library 118 is essentially a database of iCP databases, and includes a series of pointers to each of the individual iCP databases. In an embodiment, the iCP database library also includes appropriate entries to support access restrictions on the various iCP databases, so that access may be given to certain inquirers and not others.

Because the process of designing a clinical trial protocol can be extremely complex, usually requiring extensive medical and clinical knowledge, in one aspect of the invention the task is facilitated by allowing subprotocol components to be stored in a library after they are created, and re-used later in other protocols. Subprotocol components can themselves include subprotocol subcomponents which are themselves considered herein to be subprotocol components. In the object-oriented embodiments described above with respect to FIGS. 2-8 and 11-25, the subprotocol components can be any object in an iCP, and subcomponents of such subprotocol components can be any sub-objects of such objects. Referring to FIG. 1, the subprotocol components are stored in a re-usable iCP component library 130, and they are drawn upon as needed by protocol designers in step 114, as well as written to by protocol designers (or sponsors) after an iCP or a portion of an iCP is complete.

In step 120, the central authority “distributes” the iCPs from the iCP database library 118 to clinical sites which are authorized to receive them. Distribution may, for example, involve making the appropriate iCP databases available to the appropriate clinical sites. In another embodiment, “distribution” involves downloading the appropriate iCP databases from the iCP database library 118, into a site-local database of authorized iCPs. In yet another embodiment, the entire library 118 is downloaded to all of the member clinical sites, but keys are provided to each site only for the protocols for which that site is authorized access. The central authority may maintain the iCP databases only on the central server and make them available using a central application service provider (ASP) and thin-client model that supports multiple user devices including work stations, laptop computers and hand held devices.

In step 122, the individual clinical sites conduct clinical trials in accordance with one or more iCPs. The clinical site uses either a single software tool or a collection of different software tools to perform a number of different functions in this process, all driven by the iCP database. In one embodiment, in which Protégé was used as a clinical trials protocol authoring tool, a related set of “middleware” components similar to the EON execution engine originally created by Stanford University's Section on Medical Informatics, can be used to create appropriate user applications and tools which understand and which in a sense “execute” the iCP data structure. EON and its relationship to Protégé are described in the above-incorporated SMI Report Number SMI-1999-0801, and also in the following two publications, both incorporated by reference herein: Musen, et. al., “EON: A Component-Based Approach to Automation of Protocol-Directed Therapy, SMI Report No. SMI-96-0606, JAMIA 3:367-388 (1996); and Musen, “Domain Ontologies in Software Engineering: Use of Protégé with the EON Architecture,” Methods of Information in Medicine 37:540-550, SMI Report No. SMI-97-0657 (1998).

These middleware components support the development of domain-independent problem-solving methods (PSMs), which are domain-independent procedures that automate tasks to be solved. For example, the software which guides clinical trial procedures at the clinical site uses an eligibility-determination PSM to evaluate whether a particular patient is eligible for one or more protocols. The PSM is domain-independent, meaning that the same software component can be used for oncology trials or diabetes trials, and for any patient. All that changes between different trials is the protocol description, represented in the iCP. This approach is far more robust and scalable than creating a custom rule-based system for each trial, as was done in the prior art, since the same tested components can be reused over and again from trial to trial. In addition to the eligibility determination PSM, there is a therapy-planning PSM that directs therapy based on the protocol and patient data, and the accrual simulation PSM described elsewhere herein, among others.

Because of the ability to support domain-independent PSMs, the iCPs of the embodiments described herein enable automation of the entire trials process from protocol authoring to database lock. For example, the iCP is used to create multiple trial management tools, including electronic case report forms, data validation logic, trial performance metrics, patient diaries and document management reports. The iCP data structures can be used by multiple tools to ensure that the tool performs in strict compliance with the clinical protocol requirements. For example, the accrual simulation tool described above with respect to FIG. 10 is implemented as a domain-independent PSM. Similarly, an embodiment can also include a PSM that clinical sites can use to simulate their own accrual in advance of signing on to perform a given clinical trial. A single PSM is used to simulate accrual into a variety of studies, because the patient eligibility criteria are all identified in a predetermined format in the iCP for each study. Another PSM helps clinical sites identify likely patients for a given clinical trial. Yet another PSM guides clinicians through the visit-specific workflow tasks for each given patient as required by the protocol. The behavior of all these tools is guaranteed to be consistent with the protocol even as it evolves and changes because they all use the same iCP. The tools can also be incorporated into a library that can be re-used for the next relevant trial, thus permitting knowledge to be transferred across trials rather than being re-invented each time.

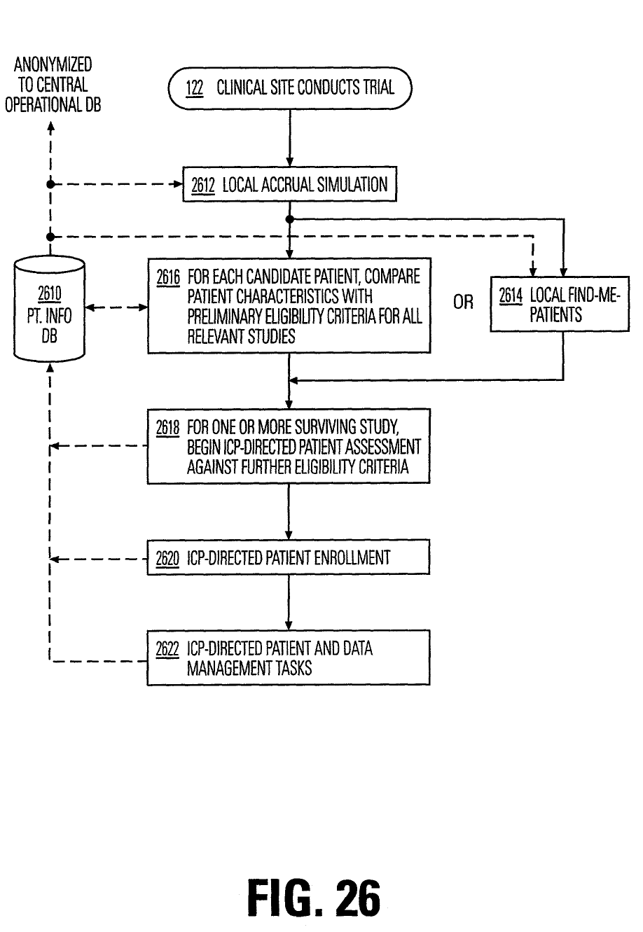

FIG. 26 is a flow chart detail of step 122 (FIG. 1). The steps in FIG. 1 typically use or contribute to a site-private patient information database 2610, which contains a number of different kinds of patient information. Because this information is maintained in conjunction with the identity of the patient, these databases 2610 are typically confidential to the clinical site or SMO, and not made available to anyone else, including study sponsors and the central authority. In one embodiment, the patient information database 2610 is located physically at the clinical site. In another embodiment, storage of the database 2610 is provided by the central authority as a service to clinical sites. In the latter embodiment, cryptographic or other security measures may be taken to ensure that no entity but the individual clinical site can view any confidential patient information.

As shown in FIG. 1, the central authority also maintains its own “operational” database 124, containing patient-anonymized patient information. The operational database 124 can be separate from the confidential patient information database(s) 2610 on which case a patient anonymized version of the patient information database 2610, or at least portions of database 2610, are transferred periodically for inclusion in an operational database 124 (FIG. 1). Alternatively, the two databases can be integrated together into one, with the central authority being denied access to sensitive patient-confidential information cryptographically.

Referring to FIG. 26, when a particular site is considering signing on to a clinical study for which it is authorized, it can first perform an accrual simulation, based on the data in its own patient information database 2610, to determine whether it is likely to accrue sufficient numbers of patients to make its participation in the study worthwhile (Step 2612). As mentioned, step 2612 is performed by a PSM which references the preliminary eligibility criteria and, in some embodiments, the further eligibility criteria for the candidate study.

After the clinical site has decided to proceed with a study, then it can use either a “Find-Me Patients” tool (step 2614) or a “QuickScreen” tool (step 2616) to identify enrollment candidates. The “Find-Me Patients” tool is either the same or different from the local accrual simulation tool, and it operates to develop a list of patients from its patient information database 2610 who are likely to satisfy the eligibility criteria for a particular protocol. The QuickScreen tool, on the other hand, for each candidate patient, compares that patient's characteristics with the preliminary eligibility criteria for all of the studies which are relevant to that clinical site.

If the candidate patient is determined to satisfy the preliminary eligibility criteria for one or more clinical trials, in step 2616, then in step 2618, the clinical site evaluates the candidate patient's medical characteristics against the further eligibility criteria for one or more of the surviving studies. This step can be performed either serially, ruling out each study before evaluating the patient against the further eligibility criteria of the next study, or partially or entirely in parallel. Preferably the step 2618 for each given study is managed by the workflow management PSM, making reference to the iCP for the given study. The iCP may direct certain patient assessment tasks which are relevant to the further eligibility criteria of the particular study. It also directs the data management tasks which are appropriate so that clinical site personnel enter the patient assessment results into the system for comparison against the further eligibility criteria. Furthermore, where possible, all data entered into the system during step 2618 is recorded in the clinical site's patient information database 2610.

After step 2618, if the patient is still eligible for one or more clinical trials, then in step 2620, the workflow management tool directs and manages the process of enrolling the patient in one of the trials. The fact of enrollment is recorded in the patient information database 2610. In step 2622, the workflow management tool, governed by the iCP database, directs all of the workflow task required at each patient visit in order to ensure compliance with the protocol. As mentioned, in accordance with the protocol, information about the patient's progress through the workflow tasks is written into the patient information database 2610, as are certain additional data called for in the data management tasks of the protocol. In one embodiment, the workflow management tool records performance/non-performance of tasks on a per patient, per visit basis. An another embodiment, more detailed patient progress information is recorded.

Returning to FIG. 1, as can be seen, patient-anonymized medical information as well as workflow progress information is uploaded from the patient information databases 2610 at each of the clinical sites in the network, to a central operational database 124. In various embodiments, some or all of these data are uploaded immediately as created, and/or on a periodic basis. The clinical study sponsors have access to the data in order to permit real time or near-real-time (depending on upload frequency) monitoring of the progress of their studies (Step 126), and the central authority also analyzes the data in the operational database 124 in order to rate the performance of each site against clinical site performance metrics (Step 128).

Such performance metrics include a site's accrual performance (actual vs. expected accrual rates), and the site's ability to deliver timely, accurate information as trials progress. The latter metrics can include such measurements as the time to complete tasks, the time from visit to entered CRF, the time from visit to closed CRF, the time from last visit to closed patient, and the time from last patient last visit to closed study. Prior art systems exist for collecting site performance data, but these systems have captured only very narrow metrics such as completion of case report forms, and the number of audits that have been conducted on the site. The prior art systems are also entirely paper-based. Most importantly, the prior art systems evaluate site performance only for a single specific study; they do not accumulate performance metrics across multiple studies at a given clinical site. In the embodiment described herein, however, the central authority gathers performance data electronically over the course of more than one study being conducted at each participating clinical site. In step 128 the central authority evaluates each site's performance against performance metrics, and these evaluations are based on each site's proven and documented past performance, typically over multiple studies conducted. Preferably, the central authority makes its site performance evaluations available to sponsors such that the best sites can be chosen for conducting clinical trials.

Study sponsors also have access to the data in the operational database 124 in order to identify promising clinical sites at which a particular new study might be conducted. For this purpose, the patient information that has been uploaded to the operational database 124 includes an indication of the clinical site at which the data were collected. The sponsor then executes a “Find-Me-Sites” PSM which queries the operational database 124 in accordance with the iCP or preliminary eligibility criteria applicable to the new protocol, and the PSM returns the number or percentage of patients in the database from each site who satisfy or might satisfy the eligibility criteria.

As mentioned above, one of the most difficult questions that a study sponsor asks during the design of a clinical trial protocol is, “How long will the study take to complete?” The encoding of the clinical trial protocol into machine readable form as described herein permits the answer to this question to be estimated automatically, or nearly so.

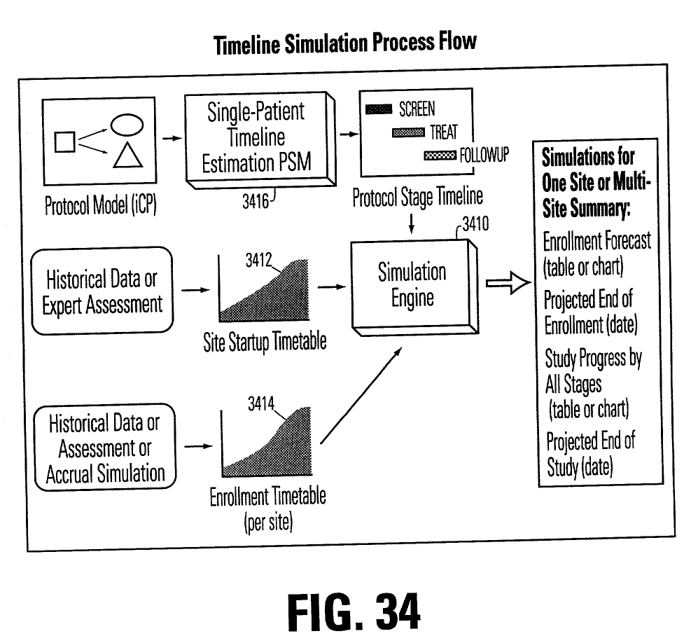

FIG. 34 illustrates the overall flow of data for the purpose of timeline forecasting. As used herein, a “timeline” is an indication of progress overtime. The term does not require that the information be presented in any particular form. Also as used herein, the term “forecasting” means to make a prediction based on assumptions. It is understood that the prediction might well turn out to be inaccurate.

Referring to FIG. 34, the actual calculation of the timeline forecast is performed by a conventional system dynamics simulation engine 3410. An example of such an engine is the Powersim Studio 2000, available from Powersim, Reston, Va. Alternatively a properly programmed spreadsheet will suffice as the simulation engine. The simulation engine divides the overall progress of a dynamic system into stages. Based on input assumptions as to how quickly individual items reach the end of each stage and move on to the next stage, the engine determines the aggregate number of items at each stage at any point in time. In FIG. 34, the simulation engine is applied to the progress of patients through the clinical trial. In particular, the clinical trial is divided into stages each terminating at a respective milestone. Based on input assumptions as to how quickly individual patients reach the end of each stage and move on to the next stage, the engine determines the aggregate number of patients at each stage at any point in time.

In general, a clinical trial protocol can be divided into stages of any desired granularity. In one embodiment, each Visit is considered a different stage for the purpose of the simulation. In the embodiment described herein, however, a clinical trial is divided into only five phases or stages, specifically site start-up, patient enrollment, patient screening, patient treatment and patient follow-up. (Some embodiments also include a separate post-enrollment-pre-treatment phase.) The site start-up phase captures the time from the commencement of the overall study to the time that individual sites are up and running and ready to enroll patients. It includes the time required for such site-specific activities as IRB review, contract negotiations, site initiation visits and regulatory document completion. In one embodiment a person familiar with the study site commencement phase provides this information based on his or her own expert assessment. In another embodiment, historical data regarding the site start-up time for individual target sites are used to predict site start-up time. In any event, the site start-up information is provided to the simulation engine 3410 as an indication 3412 of the number of sites that are expected to be ready to accept patients, at each given time after commencement of the study.

Patient enrollment information, too, can be based on expert assessment or historical data about individual sites. Patient enrollment also can be based on accrual simulation or by polling individual clinical sites with the protocol's eligibility criteria to determine how quickly the sites expect to be able to enroll patients. In the embodiment of FIG. 34, the individual per-site information is averaged together to form a generic site and provided to the simulation engine 3410 as a single per-site expected enrollment timetable 3414. The timetable 3414 indicates the number of patients that a given one of the generic sites is expected to enroll at each point in time after the site has completed its start-up phase. In another embodiment, greater precision can be obtained by grouping individual sites based on historical data into “slow” and “fast” enrolling sites, and providing separate timetables for each group. Even greater precision might be obtainable by providing a separate enrollment timetable for each of the target study sites. The level of granularity selected for modeling sites in a given embodiment can be evaluated based on the cost of additional assessments vs. the incremental value of more precise outputs. In addition, if sites are modeled individually at design-time, they can be tracked against actual experience during execution time.

The time required in the initial screening phase, the treatment phase and the follow-up phase in one embodiment can be provided based on an independent patient timeline assessment. Preferably, however, and in the embodiment described herein, these times are all calculated directly from the protocol model stored in the iCP by a single-patient timeline estimation PSM 3416. In the present embodiment, the PSM 3416 provides a single duration value for each of the three stages of a protocol. However, the user can select whether the PSM should calculate such duration values based on the minimum, maximum or preferred duration values expected for each transition in the protocol schema. The user can operate the simulation engine 3410 once for each of these variations and merge the results to provide a single visual indication showing minimum, maximum and preferred timeline forecasts. In another embodiment, instead of providing minimum and maximum durations, PSM 3416 can provide (and the iCP can support) low, base and high duration values. The low duration value is one which only some small, predetermined percentage of patents, for example 10%, are expected to exceed (i.e., require longer to complete the phase), and the high duration value is one which some predetermined large percentage of patients, for example 90%, are expected to exceed. In yet another embodiment, the PSM 3416 can provide the screening, treatment and follow-up phase durations in the form of probability distributions. Such a PSM can operate by assessing state transition probabilities in the protocol schema and building a Markov model.

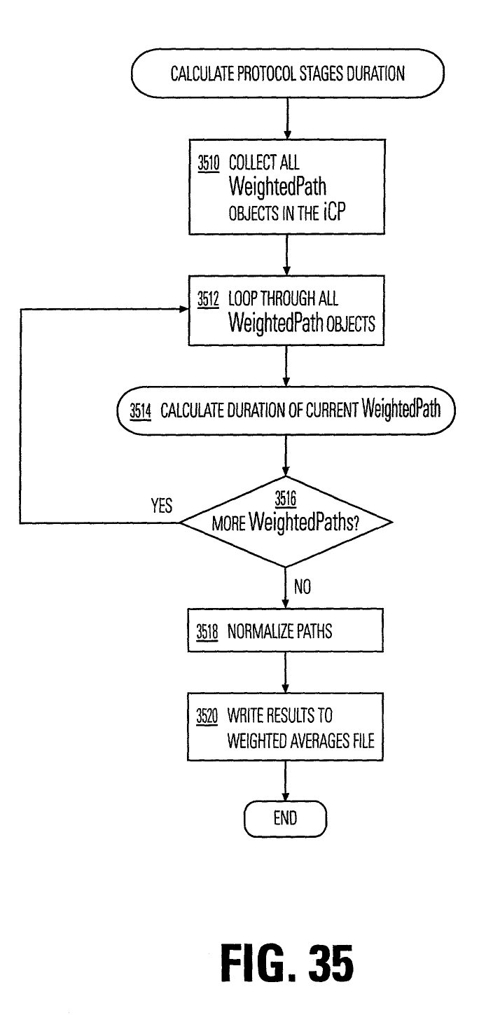

FIG. 35 is a flow chart indicating how an embodiment of PSM 3416 calculates from an iCP individual duration values for the screening, treatment and follow-up phases of the clinical trial protocol. In step 3510, the PSM collects all of the applicable WeightedPath objects from the iCP. As previously described, these objects identify a collection of Visit objects and VisitCycle objects, and further have a path weight. It will be appreciated that the visits represented in an iCP need not necessarily call for physical visits to the clinical site. They can instead include telephone conferences with a patient, or a report or survey response sent in by a patient, and so on. They may have associated therewith one or more workflow tasks identified in the protocol schema. In general, these visits can be thought of more generally as “patient contact events.” In addition, whereas in the embodiment described herein a WeightedPath object includes only patient contact events and cycles of patient contact events, it will be appreciated that in another embodiment, a WeightedPath object can also include other elements such as conditional branches, synchronization steps and so on. Thus generally, a WeightedPath object can be thought of as a collection of ProtocolPathElements (which include Visits and VisitCycles).

As previously mentioned, the VisitToVisitTransition object includes a Boolean IsPreferredTransition slot 2310. If there is more than one path from a starting object to a finishing object in the protocol schema, then the designer of the protocol can exclude very unlikely ones of such paths from the protocol duration determination by unchecking this slot for the transitions in that path. Step 3510 collects only the WeightedPath objects in which all transitions have this slot checked.

In step 3510, the programming interface to the iCP enforces the integrity of the WeightedPath objects and their components. In particular, for example, (1) there must be a valid transition between each ProtocolPathElement in the WeightedPath object; (2) there must be a valid transition between each element in a VisitCycle, and (3) all ProtocolPathElements in a VisitCycle must belong to the same phase of the protocol.

In step 3512, the PSM loops through all of the WeightedPath objects. In step 3514, the PSM calculates the duration of the current WeightedPath.

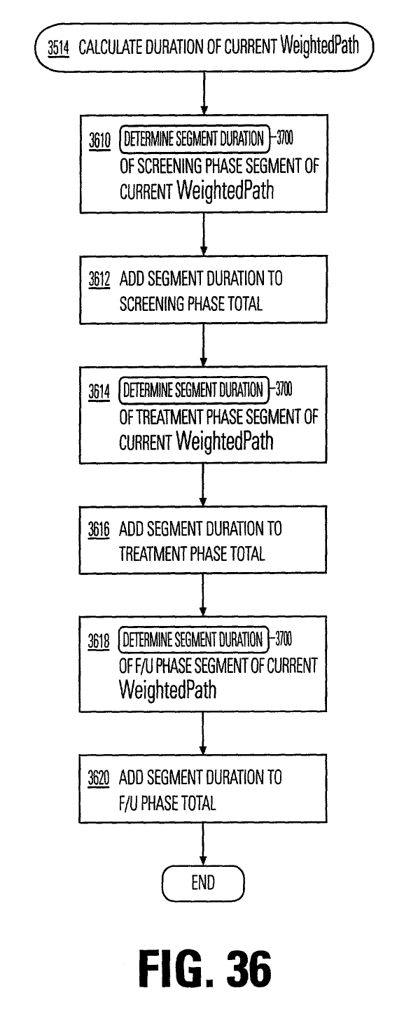

FIG. 36 is a flowchart of the step 3514 for calculating the duration of the current WeightedPath object. A single WeightedPath can span one, two or all three of the protocol phases (screening, treatment and follow-up), and the algorithm of FIG. 36 determines the duration of each segment separately. Since all screening visits appear first in the WeightedPath object, followed by all treatment visits, followed by all follow-up visits, the three segments can be considered in sequence. Thus in step 3610, the PSM determines the segment duration of the screening phase segment (if any) of the current WeightedPath object. In step 3612, the PSM weights the segment duration by the path weight value, and adds the result to a screening phase total. In step 3614, the PSM determines the segment duration of the treatment phase segment (if any) of the current WeightedPath object, and in step 3616, it weights the segment duration by the path weight value and adds the result to a treatment phase total. Similarly, in step 3618, the PSM determines the segment duration of the follow-up (F/U) phase segment (if any) of the current WeightedPath object, and in step 3620, it weights the segment duration by the path weight value and adds the result to the follow-up phase total.

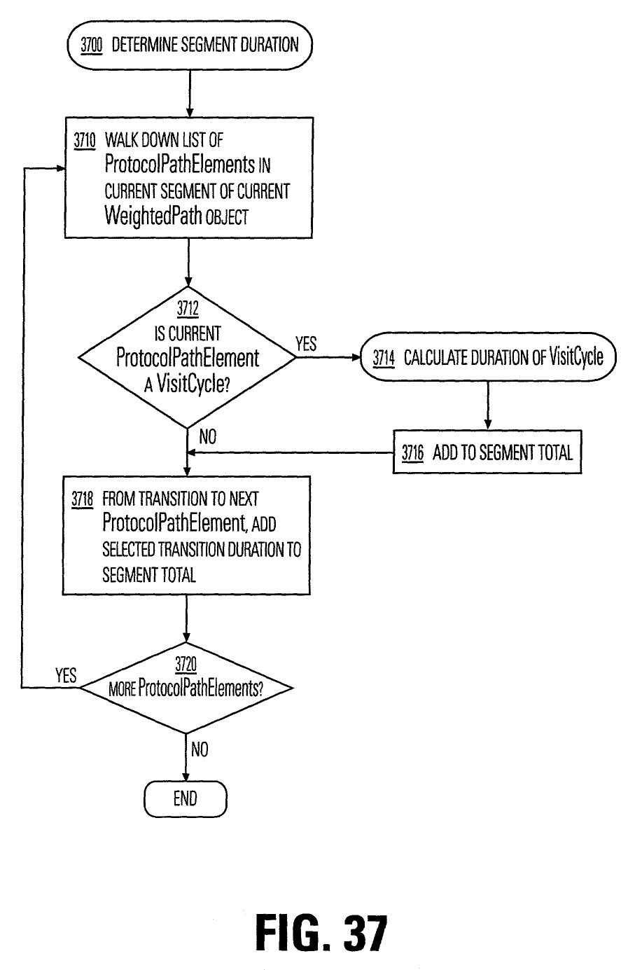

FIG. 37 is a flowchart of the algorithm for determining the segment duration for one phase of the current WeightedPath object. In step 3710, the PSM walks down the list of ProtocolPathElements in the current segment of the current WeightedPath object. In step 3712, it is determined whether the current ProtocolPathElement is a Visit or a VisitCycle object. If it is a VisitCycle object, then in step 3714 the PSM calculates the duration of the VisitCycle and adds it to the segment total (step 3716). If not, or after calculating the VisitCycle duration, then in step 3718, the PSM examines the VisitToVisitTransition object from the current ProtocolPathElement to the next ProtocolPathElement. As previously described, the presently described embodiment includes three duration values in each such transition object: a minimum, a maximum and a preferred. In another embodiment, these values can be replaced by low, high and base duration values. The algorithm described herein for calculating protocol stage durations performs the calculation with respect to only a single one of the three values as selected by a user. Thus in step 3718, the PSM adds to the segment total, the transition duration value that has been selected by the user for the current execution of the PSM. In step 3720, the PSM determines whether there are more ProtocolPathElements in the current segment of the current WeightedPath object, and if so, loops back to step 3710. Otherwise, the segment duration has been determined.

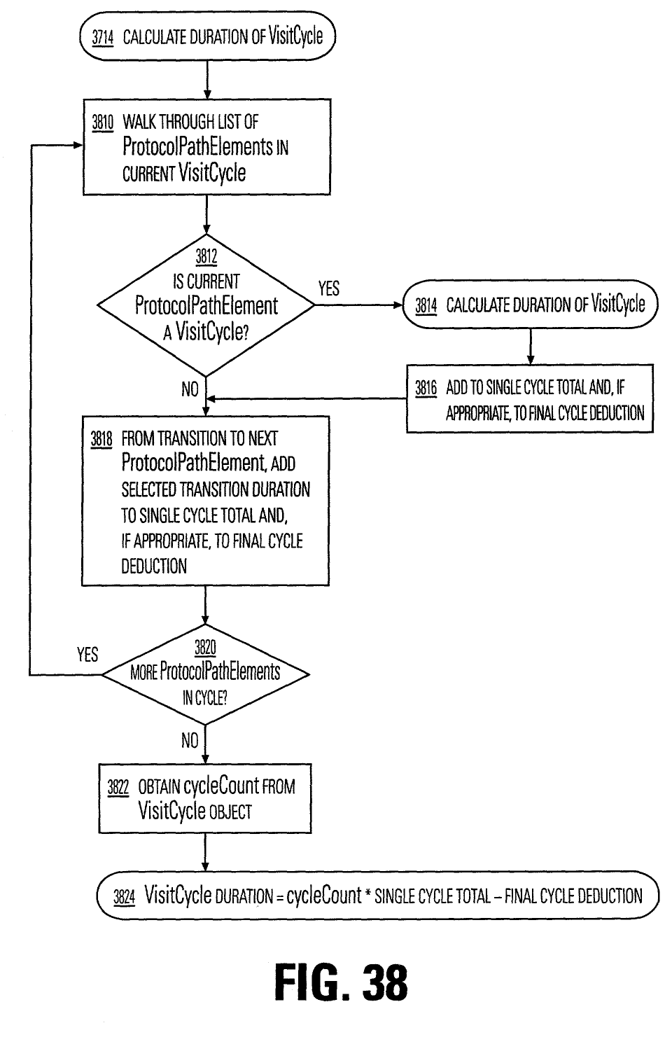

FIG. 38 is a flowchart of the procedure for calculating the duration of a visit cycle (step 3714). Since VisitCycle objects can contain additional VisitCycle objects nested to any depth, the routine 3714 for calculating the duration of a VisitCycle can be called recursively as described herein. In step 3810, the PSM walks through the list of ProtocolPathElements in the current VisitCycle. In step 3812, the PSM determines whether the current ProtocolPathElement is itself a VisitCycle. If so, then in step 3814, the PSM again calls the routine 3714 recursively to calculate the duration of this VisitCycle (step 3814). In step 3816, the calculated duration is added to a single cycle total for the current VisitCycle. In addition, if the current walk through the list of ProtocolPathElements in the current VisitCycle has previously passed the ProtocolPathElement which conditionally ends the cycle (sometimes referred to herein as the “exiting” ProtocolPathElement), then the PSM in step 3816 also adds the duration from step 3814 to a final cycle deduction amount.

In step 3818, if the current ProtocolPathElement is not a VisitCycle, or if it is and steps 3814 and 3816 have already been performed, then the PSM obtains the selected transition duration from the VisitToVisitTransition to the next ProtocolPathElement in the current VisitCycle. The PSM then adds this duration to the single cycle total for the VisitCycle, and if the current or a previously considered ProtocolPathElement is (was) the exiting ProtocolPathElement, then the transition duration is also added to the final cycle deduction amount.

In step 3820, the PSM determines whether there are more ProtocolPathElements in the current VisitCycle. If so, then control loops back to step 3810. If not, then in step 3822, the PSM obtains the cycle count from the VisitCycle object. In step 3824, the VisitCycle duration is calculated as

(cycle count*single cycle total)−final cycle deduction.

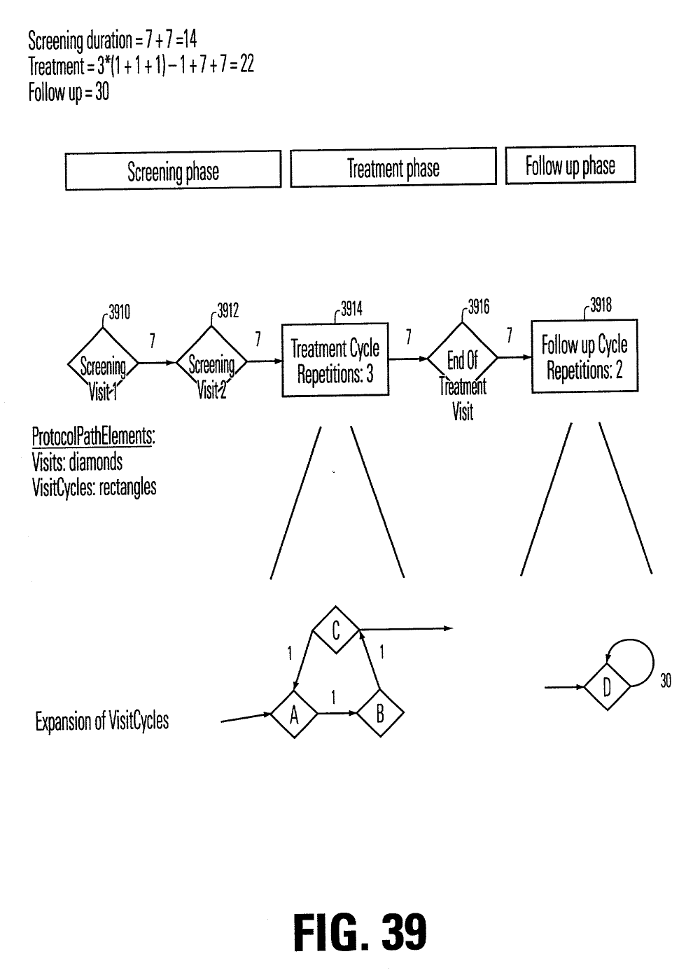

The operation of the algorithm portions of FIGS. 37 and 38 maybe best understood by reference to an example as shown in FIG. 39. FIG. 39 illustrates a path which includes visits 3910 and 3912 in the screening phase, followed by a treatment cycle 3914 and an end-of-treatment visit 3916 in the treatment phase, followed by a follow-up cycle 3918 in the follow-up phase. For simplicity, the duration between each of the ProtocolPathElements in this example are set at 7. The treatment cycle 3914 has a cycle count of 3, and is expanded below in FIG. 39. It includes visit A followed by visit B, followed by visit C, returning to visit A, with a duration of 1 between each of the visits. Visit C is the exiting ProtocolPathElement. Since the duration from visit C back to the originating visit A is one, that is the amount of the final cycle deduction.

It can be seen that the duration of the screening phase in this example is the duration of the transition from visit 3910 to visit 3912, which is 7, plus the duration of Visit 3912 to the beginning of the treatment phase, which is also 7. Thus, the total screening phase segment duration is 14. The duration of the treatment phase is the duration of the treatment cycle 3914, plus the duration of the transition from cycle 3914 to end-of-treatment 3916 (7) plus the duration of the transition from visit 3916 to the beginning of the follow-up phase (which is also 7). The duration of treatment cycle 3914 is the number of repetitions (3) times the single cycle duration (which is also 3), minus the final cycle deduction (which is 1). Thus the total duration of the treatment phase segment in this example is 3*3−1+7+7=22. The duration of the follow-up phase segment is the duration of the follow-up cycle 3918. The expansion of cycle 3918 shows a single visit D with a transition of duration 30 back to the same visit D. Visit D is also the exiting ProtocolPathElement. Since the cycle count for follow-up cycle 3918 is 2, the total duration of the follow-up phase segment in this example is 2×30−30=30.

Returning to FIG. 35, after the duration of the current WeightedPath object is calculated, in step 3516 it is determined whether there are anymore WeightedPath objects in the iCP. If so, then the PSM loops back to step 3512 to determine the duration of the next WeightedPath.

In step 3518, the durations calculated in step 3514 are combined (separately for each of the three protocol phases) to yield a duration value for each of the three phases of the protocol. In step 3520, the three values are written to a weighted averages file, from which they are transferred to the simulation engine 3410 (FIG. 34).

Returning to FIG. 34, it can be seen that the simulation engine 3410 is provided with a site start-up timetable 3412, indicating how many sites are ready to accept patients at any given time after study commencement; a per-site enrollment timetable 3414 indicating how quickly an average one of those sites enrolls patients; and three values predicting the minimum, maximum or preferred (or low, high or base) duration for which a patient is expected to remain within the screening, treatment and follow-up stages of the trial. In addition, the simulation engine 3410 is provided with a global number indicating the maximum number of patients to be enrolled in the trial, beyond which the simulation engine assumes no further enrollment. The simulation engine 3410 is also provided with information about the rate at which patients are expected to terminate early, so that the simulation engine can subtract these patients from its dynamic totals.

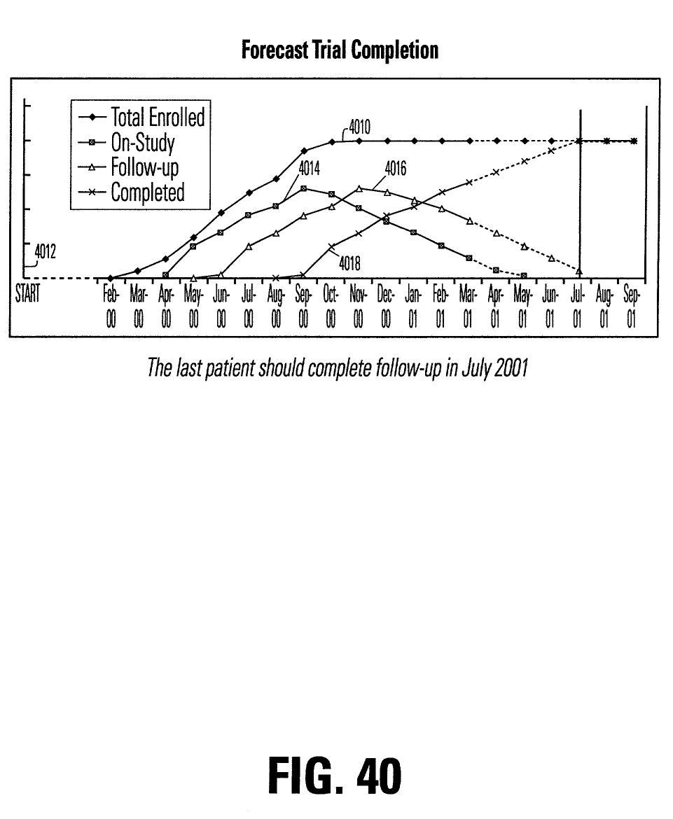

FIG. 40 is a sample output of the simulation engine 3410. On line 4010 the output indicates the total number of patients enrolled in the study. This number begins at 0 in February 2000, which is some predicted time following the study commencement date 4012, and gradually rises until it reaches its maximum in about October 2000. Enrollment remains at this level until the end of the study. (Early terminations are not considered to affect enrollment.) Line 4014 indicates the number of patients forecast to be in the treatment phase of the study at any given time. As can be seen, the first patient is expected to enter the treatment phase in April of 2000. The curve reaches a peak in about September 2000, and is expected to fall off to 0 in about May 2001. As individual patients complete the treatment phase, except for early terminations, they enter the follow-up phase indicated in line 4016 in FIG. 40. The number of patients in the follow-up phase begins at 0 in about May 2000, reaches a peak in about November 2000, and falls off to 0 in July 2001. As patients leave the follow-up stage they are considered to have “completed” their participation in the study, and they begin to be reflected in the “completed” line 4018 of the FIG. The number of patients who have completed their participation in the study begins at 0 in August of 2000, and gradually rises to equal the total number of enrolled patients, less any early terminations, in July 2001. That date, July 2001, is referred to as the date of Last-Patient, Last-Visit (LPLV).

Thus the output of the simulation engine 3410 indicates a timeline of expected patient progress through a clinical trial conducted according to a clinical trial protocol represented in a machine readable iCP database. As used herein, when an output identifies a “number of patients” at a given milestone at a given time, it is understood that such number can be expressed either as an absolute, or as a percentage or fraction of participating patients, or in any other form which is easily convertible into any of those forms. Note that in a different embodiment, the “phases” whose durations are provided by the PSM 3416 can be much more numerous and much more granular than the three illustrated in FIG. 34, even as granular as the individual ProtocolPathElements. In such an embodiment the output could indicate in separate lines the number of patients expected to be at each ProtocolPathElement at each given time. Alternatively, in yet another embodiment, if supported by the iCP and the PSM 3416, the simulation engine output can show error bars or probability distributions at each date.

One of the great advantages of operating the simulation engine 3410 based on automatically generated protocol phase duration values as in FIG. 34, is that slight changes in the protocol schema can be reflected in the timeline forecasts almost immediately. This means that if a designer of a protocol is considering increasing the time between two visits in the schema from 7 days to 8 days, a “what-if?” simulation can be performed almost immediately to predict the number of additional days that will be required for study completion. The impact of slight changes in the protocol on the completion date is often surprising and very difficult to predict absent such simulations. The same is true for slight changes in study performance assumptions such as site startup and enrollment.

The ability to re-run the simulation quickly is also highly desirable for study sponsors keeping track of actual study progress. During the conduct of the trial, the study sponsor can modify the minimum, maximum and preferred time between visits for various transitions within the protocol schema, or the path weights, to reflect the actual experience of the clinical trial sites up to that point in time. The sponsor can then easily re-run the simulation based on the new information and learn not only how far off the forecasted number of patients in each protocol phase are from the actual number at that point in time, but also how the difference will impact the study completion date. The simulation engine 3410 can output a comparison of the actual versus previously predicted curves, and/or a comparison between previously predicted curves and revised forecasts based on the actual data. The rapid forecasting ability of the system of FIG. 34, using the electronically stored protocol database, is an invaluable tool for study project managers as well as study designers.

The benefits of the system described herein extend beyond the ability to rapidly re-simulate forecasts as a result of modified input assumptions. Benefits also arise because of the system's ability to feed back actual data, during study execution, into the assumptions quickly and accurately. Typically today, when a study sponsor desires to update its timeline forecasts, it asks each study site to summarize patient progress to date through the protocol. Study site personnel typically must then manually review each patient file to determine this information, a time-consuming and labor-intensive process. Not only is the information returned to the sponsor delayed and therefore no longer fully current, but it also could contain errors, and it is also typically provided only at the coarse granularity level of major protocol stages (e.g. number of patients currently in screening, treatment and follow-up stages).

Using the system described herein, however, the actual patient progress data can be fed back into the input assumptions of the simulation engine almost as an automatic by product of patient visits as they occur in the normal course of the trial. This capability is a direct result of the system's use of a single iCP both to control the simulation engine as well as to direct patient progress through the protocol schema. In particular, the PSM used by the clinicians to identify the various tasks that the clinician will perform at each visit, also keeps track of where each patient is at any given point in time in the protocol schema. That information is maintained relative to the iCP, and therefore not only is it maintained at the fine granularity of individual patient visits, but it is also already in a form that the forecasting engine is ready to accept. No major transformations of data are required to import current fine granularity actuals back into the forecasting model to generate revised forecasts. Thus the system allows sponsors to update their timeline forecasts based on current, actual data as often as desired, with very little effort and no manual data collection or data entry, and with data maintained at the finest level of granularity supported by the iCP.

The overall flow of FIG. 34 can be modified in a number of ways for different embodiments. For example, in one embodiment, instead of providing a PSM 3416 for extracting the required information from the electronically stored iCP database and writing it to a file for subsequent importation into the simulation engine 3410, an Application Programming Interface (API) can be provided for the simulation engine 3410 to extract the information directly, as needed, from the iCP. In an embodiment, instead of extracting duration information from the iCP for the three coarse stages (screening, treatment and follow-up), and then running the simulation engine 3410 on the coarse stages, another embodiment can run the simulation engine on much finer granularity stages and then optionally combine the detailed output into coarse stage totals for presentation to the user.

As mentioned, embodiments can be designed which calculate timeline forecasts probabilistically. The following describes a Monte Carlo implementation. Markov implementations are also possible, and will be apparent to a person of ordinary skill.

In an illustrative Monte Carlo embodiment, the system first determines probability distributions for per-patient durations to reach each of the three milestones in a typical protocol (screening, treatment and follow-up). The random variables for per-site startup timetables are then determined, as are the random variables for per-site patient enrollment volume and timetables. The process flow simulations are then run multiple times with randomly varying values for each of the input random variables, and the results are accumulated and manipulated to develop the desired probabilistic timeline forecasts. Finally, the same mechanism can be used to determine how sensitive are the forecasts to variations in specific ones of the input variables.

In order to determine probability distributions for per-patient durations to reach screening, treatment and follow-up milestones of a protocol, each Transition Object in the iCP states its duration as a discrete or continuous probability distribution. In embodiments that state this probability distribution discretely, there may be only three (for example) durations stated: slow, base and fast. The “Fast” duration is the duration of the transition that exactly 25% (for example) of patients are expected to achieve or better. That is, only 25% of patients are expected to complete the transition at least as quickly as the time stated. The “Slow” duration is the duration of the transition that exactly 25% (for example) of patients are expected to be slower than. The “Base” duration is the duration of the transition that exactly 50% (for example) of patients are expected to achieve or better. The use of three stated durations is only illustrative; any arbitrary number of discrete categories may be defined in different embodiments.

In embodiments that state the duration of each Transition Object as a continuous probability distribution, the duration maybe described for example by stating the coefficients of a probability function. If a normal probability distribution is assumed, for example, on which the horizontal axis represents duration and the vertical axis represents the fraction of patients expected to take the duration specified on the horizontal axis, then the Transition Object may state only the mean and standard deviation of the normal distribution.

At each conditional branch in the iCP workflow graph, two or more alternative paths follow. Each alternative path has a WeightedPath object in the iCP, which states the probability that this path will be taken (pathWeight). Since only a finite number of discrete alternative paths can exist at a given conditional branch, the probability of each path being taken is specified discretely.

To determine the probability distributions for time to reach the screening, treatment and follow-up milestones of the protocol, the Single-Patient Timeline Estimation PSM of FIGS. 35-39 is executed multiple times. Note that in other embodiments the protocol can be organized into four or more stages, but the present description assumes three. For each iteration, the system assumes a specific value for each Transition Object duration, and that value is chosen randomly according to the probability distribution stated in the iCP for that Transition Object. For each iteration, the system also assumes a specific alternative path at each conditional branch, and that specific path is chosen randomly according to the probability distribution stated in the iCP for that alternative path. The selection of values for these random input variables can be optimized in a particular embodiment through known techniques such as Latin Hypercube.

Each iteration of the PSM yields a single duration for each of the three protocol stages. The system accumulates these durations to form three histograms, one for each protocol stage. The histogram for each protocol stage indicates a range of durations on the horizontal axis, and on the vertical axis it indicates the number of iterations that yielded that duration for that protocol stage. Note that the term “histogram” is used here only in its logical sense; a particular embodiment may or may not actually portray the accumulations visually as a histogram.

From the three histograms the system estimates the probability distribution for the duration of each respective one of the three protocol stages. The three probability distributions can be stated either as a discrete or continuous distribution, in different embodiments. If discrete distributions are provided, there may be only three durations stated for each milestone: slow, base and fast. Again, the number three is only illustrative; any arbitrary number of discrete categories may be defined. If continuous distributions are provided, the coefficients of a probability function are stated for a presumed curve shape (e.g. a normal curve shape).

In addition to estimating the probability distributions for the durations of the individual protocol stages, the random variables for the per-site startup timetable are also determined. In different embodiments, the per-site startup data can be provided in a number of different forms with a range of randomness in the input variables. In one embodiment, the per-site startup timetable is provided simply as an expected total number of sites, and a single common date at which all sites are expected to be ready to enroll patients. In the embodiment described herein, however, a probability distribution associated with the per-site startup duration is provided as well. The probability distribution of the expected per-site startup duration can be expressed either as a discrete or continuous probability distribution. If it is expressed discretely, there may be only three (for example) durations stated: slow, base and fast. The “Fast” duration is the startup duration that exactly 25% (for example) of sites are expected to achieve or better (i.e., only 25% of sites will have a startup duration that is equal to or shorter than the duration stated). “Slow” is the startup duration that exactly 25% of sites are expected to be slower than. “Base” is the startup duration that exactly 50% (for example) of sites are expected to achieve or better.

In embodiments that state the probability distribution of the expected per-site startup duration as a continuous probability distribution, the duration may be described for example by stating the coefficients of a probability function. If a normal probability distribution is assumed, for example, on which the horizontal axis represents the per-site startup duration and the vertical axis represents the fraction of sites expected to take the duration specified on the horizontal axis to complete their startup phase, then the probability distribution of the expected per-site startup duration may state only the mean and standard deviation of the normal distribution.

Note that in other embodiments, the study sponsor might divide the sites into two or more “kinds”, and provide (1) the fraction of each kind of site expected to participate in the study; and (2) separate per-site startup duration information for each kind of site. Again, each of these startup durations may include a probability distribution, in which case the probability of each startup duration will be the product of the probability that a given site is in a particular “kind”, and the probability that the given site is slow, base or fast for the particular kind. A wide variety of other forms exist in which per-site startup data can be provided, and the reader will be able to adapt the description herein in accordance therewith.

The per-site patient enrollment volume and timetables, too, can be provided in a number of different forms with a range of randomness in the input variables in different embodiments. In the presently described embodiment, externally supplied data include the total number of patients that each particular site is expected to enroll, expressed as a discrete or continuous probability distribution, and the expected per-site time to reach full enrollment, also expressed as a discrete or continuous probability distribution. As for per-site startup data described above, in other embodiments, the study sponsor might divide the sites into two or more “kinds”, and provide (1) the percentage of each kind of site expected to participate in the study; and (2) separate peak enrollment information and patient enrollment rates for each kind of site. Again, each of these data may include a probability distribution.

Thus the inputs to the process flow simulation engine include a discrete or continuous probability distribution for the duration of each respective one of the three (for example) protocol stages, and per-site startup data and per-site enrollment data as described above. Inputs also may include a global total patient enrollment limit.

To determine the probability distributions for the time from study commencement at which each milestone will occur, the system performs multiple simulations of the process, from study commencement through the last visit in the protocol. Each iteration randomly assigns a value to each of the input random variables from their respective probability distributions. Since each iteration assumes a randomly selected value for the per-patient timetable, for each iteration the system assumes a specific value for the duration of the screening phase of the protocol. That value is chosen randomly according to the probability distribution provided for the duration of the screening phase of the protocol. For the same reason, for each iteration the system also assumes a specific value for the duration of the treatment phase of the protocol, and also a specific value for the duration of the follow-up phase of the protocol. These values, too, are chosen randomly according to their respective probability distributions. Although this description assumes only three random variables for three milestones, models containing additional milestones can be extended by the addition of additional random variables using the same methodology.

Each iteration of the simulation also assumes specific values for the per-site enrollment volume and timetable. The values selected for these variables, too, are chosen randomly according to the probability distributions provided for them. Other parameters, for example patient early termination rates, may also be selected at random in a given embodiment. As above, the selection of values for the random input variables can be optimized through known techniques such as Latin Hypercube.

Each iteration through the simulation engine yields a single time from study commencement at which each milestone will occur. The system accumulates these to form separate histograms (logically speaking), one for each milestone. The histogram for each milestone indicates on the horizontal axis a range of times from study commencement, and on the vertical axis it indicates the number of iterations that yielded that time for that milestone. These histograms can be used to develop timeline forecasts such as that shown in FIG. 40, showing curves indicating at each point in time the number of patients expected to be enrolled in the study, the number of patients expected to be “on-study”, the number expected to be “in follow-up,” and the number expected to have completed their participation in the study. These curves can show “base” values for these numbers, for example derived from the weighted average times in the milestone histograms, or they can show “low” or “high” values. Alternatively they can show “base” values with vertical error bars indicating the “low” and “high” values. Alternatively the histograms can be used to develop a timeline forecast of the number of patients who have completed the study at each point in time, showing separate “low”, “base” and “high” curves. As yet another alternative, the histograms can be used to show discrete or continuous probability distributions for the time from study commencement that each milestone (including LPLV) will occur. Many other presentations of this data will be apparent.

The same simulation engine can also be used to perform a single variable sensitivity analysis, to determine which ones of the input random variables are the most significant in driving the forecast timelines. This can be accomplished by holding all the input random variables at their “base” case values except one, and letting only that one vary for multiple iterations through the simulation engine. This process can be repeated for each individual random variable, holding all other variables at their respective “base” case values and allowing only the individual variable singularly to vary according to its probability function. The results of this process can be plotted as a “tornado” diagram ranking the input variables according to the extent of their influence on the forecast timelines. A multi-variable sensitivity analysis can be performed in a similar manner. These sensitivity analyses can be used by study sponsors and authors to better allocate resources to improve those variables over which they have influence and which have greater significance in the resulting forecast timelines.

The timeline forecast in FIG. 40 predicts an answer to the question, “If the study commences on date X, how many patients will be at each stage in the protocol, or at LPLV, at any given future point in time?” Thus, this is a “forward-looking” timeline of expected patient progress. The system can equally well be used to create “backward-looking” timelines, for example answering the question, “If I want to have X patients in the Y stage of the protocol (or if I want LPLV) by a particular date, when do I need to commence the study?” Both of these questions are important to study sponsors and can be answered predictively by the system described herein.

It can be seen that the forecasts generated by the simulation engine 3410 are based on certain assumptions about the site start-up timetable 3412, the patient enrollment timetable 3414, and about various aspects of patient-progress through the protocol schema (such as the number of days between visits, the number of repetitions of a visit cycle, and the weight to be accorded to multiple parallel paths to a common destination object in the protocol schema). These assumptions can be based on expert assessment. Additionally, where portions of the protocol (such as eligibility criteria or a sub-graph in the protocol schema) were borrowed from other protocols previously executed, assumptions for patient enrollment and for the pertinent parts of patient progress through the protocol schema can be estimated based on historical patient progress data with such previously executed protocols. In yet another embodiment, the site startup and/or enrollment timetable assumptions can be provided in probabilistic or error-barred form, or in 80%/20% or 90%/10% form, rather than with a specific number for each point in time.

In a particularly beneficial variation the input assumptions to the simulation engine 3410 can be revised to take into account actual experience as the study progresses. For example, as study sites begin enrolling patients, it may become apparent that the initial estimates assumed during design-time were incorrect. Using the system described herein, the sponsor can reconsider these estimates based on actual data to date and quickly re-simulate the forecasts to improve their accuracy. Not only can the improved information benefit the study sponsor's normal business planning efforts, but if it indicates a significant departure from the pre-study forecasts, it also permits the study author to re-simulate additional changes in future durations to potentially find an acceptable “repair”.

As used herein, a given event or value is “responsive” to a predecessor event or value if the predecessor event or value influenced the given event or value. If there is an intervening step or time period, the given event or value can still be “responsive” to the predecessor event or value. If the intervening step combines more than one event or value, the output of the step is considered “responsive” to each of the event or value inputs. If the given event or value is the same as the predecessor event or value, this is merely a degenerate case in which the given event or value is still considered to be “responsive” to the predecessor event or value. “Dependency” of a given event or value upon another event or value is defined similarly.

The foregoing description of preferred embodiments of the present invention has been provided for the purposes of illustration and description. It is not intended to be exhaustive or to limit the invention to the precise forms disclosed. Obviously, many modifications and variations will be apparent to practitioners skilled in this art. In particular, and without limitation, any and all variations described, suggested or incorporated by reference in the Background section of this patent application are specifically incorporated by reference into the description herein of embodiments of the invention. The embodiments described herein were chosen and described in order to best explain the principles of the invention and its practical application, thereby enabling others skilled in the art to understand the invention for various embodiments and with various modifications as are suited to the particular use contemplated. It is intended that the scope of the invention be defined by the following claims and their equivalents.

1. A method for preparing a timeline for a clinical trial, comprising the steps of:
providing a machine readable protocol database, said protocol database identifying a sequence of workflow tasks for a first clinical trial protocol; and
in dependence upon said protocol database, automatically generating a timeline of expected patient progress through at least a portion of said workflow tasks during a first clinical trial to be conducted according to said first clinical trial protocol.

2. A method according to claim 1, wherein said timeline of expected patient progress is forward-looking.

3. A method according to claim 1, wherein said step of automatically generating comprises the step of generating said timeline in dependence upon actual patient progress through said portion of workflow tasks during a previous execution of a clinical trial according to said first clinical trial protocol.

4. A method according to claim 1, wherein said step of providing a machine readable protocol database comprises the step of copying said portion of workflow tasks from a prior clinical trial protocol,
and wherein said step of automatically generating comprises the step of generating said timeline in dependence upon actual patient progress through said portion of workflow tasks during a previous execution of a clinical trial according to said previous clinical trial protocol.

5. A method according to claim 1, wherein said step of automatically generating comprises the step of developing said timeline in dependence upon the simulated progress of a first hypothetical patient through said portion of said workflow tasks.

6. A method according to claim 5, wherein said step of developing said timeline is performed further in dependence upon the actual progress of a first actual patient through at least a portion of said workflow tasks.

7. A method according to claim 5, further comprising the step of automatically re-generating a timeline of expected patient progress through at least a portion of said workflow tasks, in dependence upon the actual progress of a first actual patient through at least a portion of said workflow tasks.

8. A method according to claim 1, wherein said workflow tasks include both patient management tasks and data management tasks.

9. A method according to claim 1, wherein said workflow tasks are grouped into a plurality of patient contact events, each of said patient contact events having associated therewith at least one of said workflow tasks,
and wherein said protocol database identifies a sequence of workflow tasks at least in part by identifying a sequence of said patient contact events.

10. A method according to claim 9, wherein at least one of said patient contact events includes an office visit.

11. A method according to claim 9, wherein said protocol database identifies said sequence of patient contact events at least in part by organizing said patient contact events as a workflow graph.

12. A method according to claim 1, wherein said protocol database identifies a plurality of stages in said sequence of workflow tasks,
and wherein said step of automatically generating comprises the step of predicting the number of patients who will be in each of said stages at a given point in time.

13. A method according to claim 12, wherein said stages include a treatment stage and a follow-up stage.

14. A method according to claim 1, wherein said step of automatically generating comprises the step of predicting the number of patients who will have completed their participation in said first clinical trial at a given point in time.

15. A method according to claim 1, wherein said step of automatically generating comprises the step of predicting a last patient, last patient contact date for said first clinical trial.

16. A method according to claim 1, wherein said protocol database identifies a plurality of stages in said sequence of workflow tasks, and wherein said step of automatically generating comprises the steps of:
predicting the best case number of patients who will be in each of said stages at a given point in time; and
predicting the worst case number of patients who will be in each of said stages at a given point in time.

17. A method according to claim 1, wherein said step of automatically generating includes the step of predicting the progress of said first clinical trial in response to the simulated progress of an assumed typical patient through at least said portion of said workflow tasks.

18. A method according to claim 1, wherein said step of automatically generating includes the step of predicting the progress of said first clinical trial in response to the simulated progress of a plurality of hypothetical patients through at least said portion of said workflow tasks.

19. A method according to claim 18, wherein said plurality of hypothetical patients includes:
a first hypothetical patient assumed to progress most slowly through said portion of workflow tasks, and
a second hypothetical patient assumed to progress most quickly through said portion of workflow tasks.

20. A method according to claim 18, wherein said plurality of hypothetical patients includes:
a first hypothetical patient assumed to progress through said portion of workflow tasks at a rate which is no slower than a predetermined percentage of patients participating in said first clinical trial, and
a second hypothetical patient assumed to progress through said portion of workflow tasks at a rate which is no faster than said predetermined percentage of patients participating in said first clinical trial.

21. A method according to claim 1, wherein said sequence of workflow tasks is organized as a workflow graph having a plurality of alternative paths to a common destination node,
and wherein said step of automatically generating a timeline of expected patient progress through a portion of said workflow tasks comprises the step of making an assumption about how likely it is that a first hypothetical patient will follow each of said alternative paths.

22. A method according to claim 21, wherein said step of making an assumption is dependent upon the simulated prior progress of said first hypothetical patient through said workflow tasks.

23. A method according to claim 1, further comprising the steps of:
modifying said machine readable protocol database; and
in dependence upon said modified protocol database, automatically generating a revised timeline of expected patient progress through said portion of said workflow tasks.

24. A method according to claim 23, further comprising the step of displaying said revised timeline in conjunction with the timeline generated in dependence upon the unmodified protocol database.

25. A method according to claim 23, comprising the step of iteratively modifying said machine readable protocol database and automatically generating revised timelines, until an acceptable timeline is generated.

26. A method according to claim 23, wherein said step of modifying said machine readable protocol database is dependent upon actual patient progress experience through said portion of said workflow tasks.

27. A method according to claim 1, wherein said sequence of workflow tasks includes a plurality of protocol path elements,
wherein said machine readable protocol database identifies typical time periods between said protocol path elements,
and wherein said step of automatically generating comprises the step of simulating the progress of a first hypothetical patient through said portion of said workflow tasks in dependence upon said typical time periods.

28. A method according to claim 1, wherein said sequence of workflow tasks includes a plurality of protocol path elements,
wherein said machine readable protocol database identifies minimum and maximum expected time periods between said protocol path elements,
and wherein said step of automatically generating comprises the step of simulating the progress of first and second hypothetical patients through said portion of said workflow tasks in dependence upon said minimum and maximum expected time periods, respectively.

29. A method according to claim 1, wherein said sequence of workflow tasks includes a plurality of protocol path elements,
wherein said machine readable protocol database identifies first and second expected time periods between each sequential origin and destination pair of said protocol path elements, the first expected time period being the time expected for a first predetermined fraction of participating patients to progress from the origin protocol path element of the pair to the destination protocol path element of the pair, and the second expected time period being the time expected for a second predetermined fraction of participating patients to progress from the origin protocol path element of the pair to the destination protocol path element of the pair,
and wherein said step of automatically generating comprises the step of simulating the progress of first and second hypothetical patient through said portion of said workflow tasks in dependence upon said first and second expected time periods, respectively.

30. A method according to claim 1, wherein said sequence of workflow tasks includes a plurality of protocol path elements,
wherein said machine readable protocol database identifies probability distributions of the expected time periods between said protocol path elements,
and wherein said step of automatically generating comprises the step of simulating the progress of a first hypothetical patient through said portion of said workflow tasks in dependence upon said probability distributions.

31. A method according to claim 1, wherein said sequence of workflow tasks includes a plurality of protocol path elements,
wherein said machine readable protocol database identifies first expected time periods between said protocol path elements,
further comprising the step of pre-calculating an expected duration for a first protocol phase in dependence upon said first expected time periods within said first protocol phase,
and wherein said step of automatically generating comprises the step of simulating the progress of a first hypothetical patient through said portion of said workflow tasks in dependence upon said pre-calculated expected duration for said first protocol phase.

32. A method according to claim 31, further comprising the step of pre-calculating an expected duration for a second protocol phase in dependence upon said first expected time periods within said second protocol phase,
and wherein said step of automatically generating comprises the step of simulating the progress of a first hypothetical patient through said portion of said workflow tasks further in dependence upon said pre-calculated expected duration for said second protocol phase.

33. A method according to claim 31, wherein said expected time periods between protocol path elements represent typical time periods.

34. A method according to claim 33, wherein said machine readable protocol database further identifies second expected time periods between said protocol path elements,
and wherein said step of pre-calculating an expected duration is performed further in dependence upon said second expected time periods between said protocol path elements.

35. A method according to claim 1, wherein said step of automatically generating occurs in dependence upon an assumed study site commencement timeline.

36. A method according to claim 35, further comprising the step of providing said assumed study site commencement timeline in dependence upon expert assessment.

37. A method according to claim 35, further comprising the step of providing said assumed study site commencement timeline in dependence upon historical information about the commencement time of a prior-begun study by a study site expected to participate in said first clinical trial.

38. A method according to claim 35, wherein said site commencement timeline includes an assumed number of participating study sites.

39. A method according to claim 35, wherein said site commencement timeline includes an assumed setup time for each participating study site.

40. A method according to claim 35, wherein said assumed study site commencement timeline represents a typical expected study site commencement time for a hypothetical study site.

41. A method according to claim 35, wherein said assumed study site commencement timeline includes expected best and worst case study site commencement times.

42. A method according to claim 35, wherein said assumed study site commencement timeline identifies a first time period within which a first predetermined fraction of the participating study sites are expected to commence said first clinical trial, and a second time period within which a second predetermined fraction of the participating study sites are expected to commence said first clinical trial.

43. A method according to claim 35, wherein said assumed study site commencement timeline includes a probability distribution identifying, for each given study site expected to participate, the probability that the given study site will commence said first clinical trial at various times.

44. A method according to claim 35, further comprising the steps of:
modifying said assumed study site commencement timeline in dependence upon the actual study site commencement time of a first study site participating in said first clinical trial; and
in dependence upon said modified study site commencement timeline, automatically generating a revised timeline of expected patient progress through said portion of said workflow tasks.

45. A method according to claim 1, wherein said step of automatically generating occurs in dependence upon an assumed patient enrollment timeline.

46. A method according to claim 45, further comprising the step of providing said assumed patient enrollment timeline in dependence upon expert assessment.

47. A method according to claim 45, further comprising the step of providing said assumed patient enrollment timeline in dependence upon historical information about the patient enrollment timeline of a prior-begun study by a study site expected to participate in said first clinical trial.

48. A method according to claim 45, further comprising the step of providing said assumed patient enrollment timeline in dependence upon a typical expected patient enrollment timeline for a hypothetical study site.

49. A method according to claim 45, wherein said assumed patient enrollment timeline includes expected best and worst case patient enrollment timeline aspects.

50. A method according to claim 45, wherein said assumed patient enrollment timeline identifies a first time period within which a first predetermined fraction of the patients expected to be enrolled in said first clinical trial at a given study site are expected to have done so, and a second time period within which a second predetermined fraction of the patients expected to be enrolled in said first clinical trial at said given study site are expected to have done so.

51. A method according to claim 45, wherein said assumed patient enrollment timeline includes a probability distribution identifying, for a given study site, the probability that the given study site will have enrolled various numbers of patients in said first clinical trial by a given time.

52. A method according to claim 45, further comprising the steps of:
modifying said assumed patient enrollment timeline in dependence upon the actual patient enrollment experience during execution of said first clinical trial; and
in dependence upon said modified patient enrollment timeline, automatically generating a revised timeline of expected patient progress through said portion of said workflow tasks.

53. At least one computer readable medium collectively carrying a machine readable protocol database identifying:
a sequence of workflow tasks for a first clinical trial protocol; and
a value indicating an expected time period between performance of a first one of said workflow tasks for a given patient and performance of a second one of said workflow tasks for said given patient.

54. A medium according to claim 53, wherein said sequence of workflow tasks includes a plurality of protocol path elements,
and wherein said machine readable protocol database identifies expected time periods between each sequential origin and destination pair of said protocol path elements.

55. A medium according to claim 54, wherein said plurality of protocol path elements are organized to include a plurality of alternative paths from a beginning protocol path element to an ending protocol path element,
and wherein said machine readable protocol database identifies a relative pathweight for each of said paths.

56. A medium according to claim 53, wherein said workflow tasks include both patient management tasks and data management tasks.

57. A medium according to claim 53, wherein said workflow tasks are grouped into a plurality of patient contact events, each of said patient contact events having associated therewith at least one of said workflow tasks,
and wherein said protocol database identifies said sequence of workflow tasks at least in part by identifying a sequence of said patient contact events.

58. A medium according to claim 57, wherein at least one of said patient contact events includes an office visit.

59. A medium according to claim 57, wherein said protocol database identifies said sequence of patient contact events at least in part by organizing said patient contact events as a workflow graph.

60. A medium according to claim 53, wherein said protocol database identifies a plurality of stages in said sequence of workflow tasks.

61. A medium according to claim 60, wherein said stages include a treatment stage and a follow-up stage.

62. A medium according to claim 53, wherein said sequence of workflow tasks includes a plurality of protocol path elements,
wherein said expected time value represents a typical time period.

63. A medium according to claim 53, wherein said sequence of workflow tasks includes a plurality of protocol path elements,
wherein said expected time value represents a minimum time period,
and wherein said machine readable database further identifies a maximum expected time period between performance of said first workflow task for said given patient and performance of said second workflow task for said given patient.

64. A medium according to claim 53, wherein said sequence of workflow tasks includes a plurality of protocol path elements,
and wherein said machine readable protocol database identifies first and second expected time periods between each sequential origin and destination pair of said p protocol path elements, the first expected time period being the time expected for a first predetermined fraction of participating patients to progress from the origin protocol path element of the pair to the destination protocol path element of the pair, and the second expected time period being the time expected for a second predetermined fraction of participating patients to progress from the origin protocol path element of the pair to the destination protocol path element of the pair.

65. A medium according to claim 53, wherein said sequence of workflow tasks includes a plurality of protocol path elements,
and wherein said machine readable protocol database identifies probability distributions of the expected time periods between said protocol path elements.
